(19) United States
(12) Patent Application Publication
(10) Pub. No.: US 2026/0140638 A1
(43) Pub. Date: May 21, 2026

(54) STORAGE DEVICE INCLUDING STORAGE CONTROLLER AND OPERATION METHOD OF STORAGE CONTROLLER

(71) Applicant: Samsung Electronics Co., Ltd., Suwon-si (KR)

(72) Inventors: HANSOL PARK, Suwon-si (KR); JIN-HEE MA, Suwon-si (KR); DONGYOON KANG, Suwon-si (KR); Seulgi SHIN, Suwon-si (KR); JUNGJAE WOO, Suwon-si (KR); SEOKHWAN CHOI, Suwon-si (KR)

(21) Appl. No.: 19/352,216

(22) Filed: Oct. 7, 2025

(30) Foreign Application Priority Data
Nov. 21, 2024 (KR) 10-2024-0167162

(51) Int. Cl. G06F 3/06

(52) U.S. Cl. CPC G06F 3/0619; G06F 3/0644; G06F 3/0679

(57) ABSTRACT

A storage device includes a non-volatile memory device, and a storage controller. The non-volatile memory device includes a first memory region and a second memory region, each of the first and second regions including a plurality of memory blocks and distinguished through a first boundary. The first memory region is divided into a first region and a second region through a second boundary. The second memory region is divided into a third region and a fourth region through a third boundary. The first region includes a plurality of first reserved blocks configured to replace a bad block of the second region. The fourth region includes a plurality of second reserved blocks configured to replace a bad block of the third region. The number of bits stored in each memory cell of the first memory region is different from the number of bits stored in each memory cell of the second memory region.

### CROSS-REFERENCE TO RELATED APPLICATION

This application claims priority under 35 U.S.C. §119 to Korean Patent Application No. 10-2024-0167162 filed on Nov. 21, 2024, in the Korean Intellectual Property Office, the disclosure of which is incorporated by reference herein in its entirety.

### BACKGROUND

Embodiments of the present disclosure described herein relate to a semiconductor memory device, and more particularly, relate to a storage device including a storage controller and an operation method of the storage controller.

A semiconductor memory device may be classified into a volatile memory device and a non-volatile memory device based on data retention characteristics. The volatile memory device, such as a static random access memory (SRAM) or a dynamic random access memory (DRAM), may lose data stored therein when a power supply is cut off. On the other hand, the non-volatile memory device, such as a flash memory, a phase-change RAM (PRAM), a magnetic RAM (MRAM), a resistive RAM (RRAM), or a ferroelectric RAM (FRAM), may retain data stored therein even when the power supply is cut off.

Because of high density characteristics, flash memory is widely used for a high-capacity storage device. A storage device may store data under control of a host device, such as a computer, a smartphone, or a smart pad. The storage device may store data on a magnetic disk such as a hard disk drive (HDD), or in a semiconductor memory device, in particular, in a non-volatile memory device, such as a solid state drive (SSD) or a memory card.

### SUMMARY

Embodiments of the present disclosure provide a storage device including a storage controller with improved performance and an operation method of the storage controller.

According to an embodiment, a storage device includes a non-volatile memory device, and a storage controller, the storage controller being configured to store first boundary information, second boundary information and third boundary information, wherein the non-volatile memory device includes a first memory region and a second memory region distinguished through a first boundary identified by the first boundary information of the storage controller, each of the first memory region and the second memory region including a plurality of memory blocks, wherein the first memory region is divided into a first region and a second region, the first region includes a plurality of first reserved blocks, the second region includes a plurality of first user memory blocks, a second boundary between the first region and the second region is identified by the second boundary information of the storage controller, wherein the second memory region is divided into a third region and a fourth region, the third region includes a plurality of second user memory blocks, the fourth region includes a plurality of second reserved blocks, and a third boundary between the third region and the fourth region is identified by the third boundary information of the storage controller, wherein the storage controller is configured to replace a bad block of the second region with a corresponding first reserved block and cause the first reserved block to be identified as a first user memory block, wherein the storage controller is configured to replace a bad block of the third region with a corresponding second reserved block and cause the second reserved block to be identified as a second user memory block, and wherein each memory cell in the first memory region is configured to store m-bit data, and each memory cell in the second memory region is configured to store n-bit data, and m and n are natural numbers and are different from each other.

According to an embodiment, an operation method of a storage controller for controlling a non-volatile memory device which includes a first memory region and a second memory region distinguished by first boundary information, and each of the first and second memory regions including a plurality of memory blocks includes dividing the first memory region into a first region and a second region through second boundary information, dividing the second memory region into a third region and a fourth region through third boundary information, replacing a first bad block of the second region with a first memory block among the plurality of memory blocks of the first region, replacing a second bad block of the third region with a second memory block among the plurality of memory blocks of the fourth region, extracting a third memory block among the plurality of memory blocks of the second region as a reserved block, replacing a second bad block of the second region with the third memory block, and expanding the first region to include the third memory block, by changing the second boundary between the first region and the second region, wherein each memory cell of the first memory region is configured to store m-bit data, and each memory cell of the second memory region is configured to store n-bit data, and m and n are natural numbers and different from each other.

According to an embodiment, a storage device includes a non-volatile memory device including a plurality of memory blocks, and a storage controller, wherein the storage controller is configured to allocate the plurality of memory blocks to a first memory region and a second memory region through a first boundary information in response to a first request from an external host device, divide the first memory region into a first region and a second region through a second boundary information based on a number of initial bad blocks of the first memory region, replace a bad block of the second region with a first memory block among the plurality of memory blocks of the first region, divide the second memory region into a third region and a fourth region through a third boundary information based on the number of initial bad blocks of the second memory region, in which the third region is adjacent to the second region and the fourth region adjacent to the third region, replace a bad block of the third region with a second memory block among the plurality of memory blocks of the fourth region, change the second boundary information based on a number of runtime bad blocks of the second region, and change the third boundary information based on a number of runtime bad blocks of the third region, wherein each memory cell of the first memory region stores m-bit data, each memory cell of the second memory region stores n-bit data, and m and n are natural numbers and different from each other.

### BRIEF DESCRIPTION OF THE DRAWINGS

The above and other objects and features of the present disclosure will become apparent through detailed description of embodiments with reference to the accompanying drawings.

FIG. 1 is a block diagram illustrating a storage device according to an embodiment of the present disclosure.

FIG. 2 is a block diagram for describing a storage controller of FIG. 1.

FIG. 3 is a block diagram illustrating a non-volatile memory device of FIG. 1.

FIG. 4 is a circuit diagram illustrating a first memory block included in a memory cell array of FIG. 3.

FIG. 5A is a flowchart for describing an operation of a storage controller performing initial allocation of memory blocks to first to fourth regions a memory cell array of FIG. 3.

FIG. 5B is a diagram for describing regions of a memory cell array of FIG. 3 after initial allocation is performed.

FIG. 5C is a diagram for describing a boundary information table after initial allocation is performed.

FIG. 6 is a flowchart for describing a bad block management method of a storage controller of FIG. 1.

FIG. 7 is a flowchart for describing an operation of replacing a bad block with a reserved block of a first region of FIG. 6.

FIG. 8A is a diagram for describing bad block management of a bad block manager of FIG. 1, FIG. 8B is a diagram for describing a bad block mapping table of FIG. 2, and FIG. 8C is a diagram for describing a boundary information table of FIG. 2.

FIG. 9 is a flowchart for describing a reserved block extracting operation of FIG. 7.

FIG. 10 is a flowchart for describing an operation of performing a remap operation on an extracted reserved block and a bad block, which is described with reference to FIG. 7.

FIG. 11 is a diagram for describing operations of FIGS. 9 and 10.

FIG. 12 is a flowchart for describing a re-partitioning operation of a storage controller of FIG. 1.

FIG. 13 is a flowchart for describing a re-partitioning operation of FIG. 12.

FIG. 14 is a diagram for describing an example of a re-partitioning operation.

FIGS. 15A and 15B are diagrams for describing an example of a re-partitioning operation according to an embodiment of the present disclosure.

FIGS. 16A and 16B are diagrams for describing an example of a re-partitioning operation according to an embodiment of the present disclosure.

FIG. 17 is a diagram illustrating a system according to an embodiment of the present disclosure.

### DETAILED DESCRIPTION OF THE EMBODIMENTS

Embodiments of the present disclosure will be described in detail and clearly to an extent that an ordinary person in the art can easily implement the present disclosure.

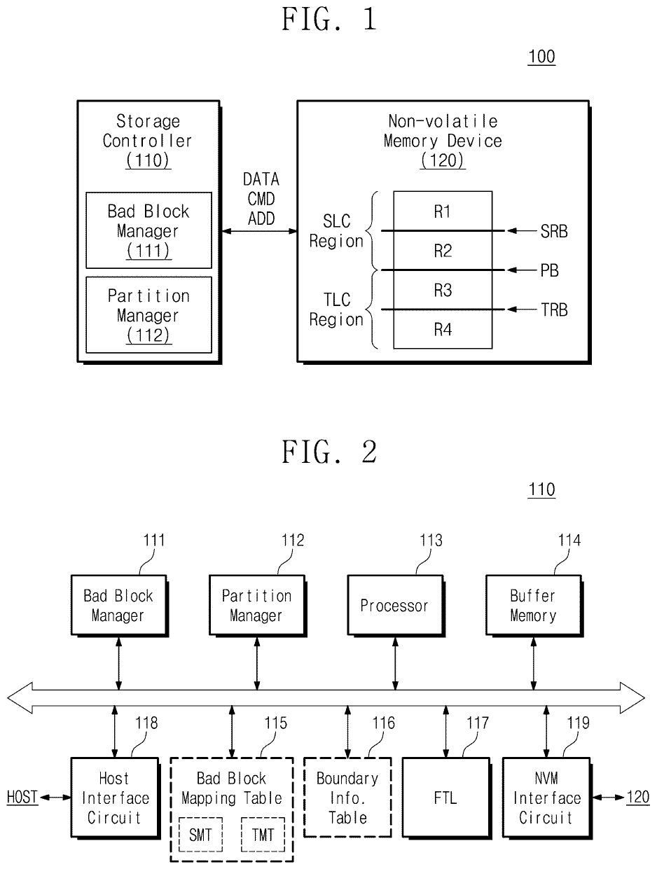

FIG. 1 is a block diagram illustrating a storage device according to an embodiment of the present disclosure. Referring to FIG. 1, a storage device 100 may include a storage controller 110 and a non-volatile memory device 120. In response to a request from an external host device, the storage controller 110 may control the non-volatile memory device 120 to store data “DATA,” or to read the data “DATA” stored in the non-volatile memory device 120, and may transmit the data “DATA” read from the non-volatile memory device 120 to the external host device. The storage controller 110 may transmit a command CMD and an address ADD to the non-volatile memory device 120 to store the data “DATA” in the non-volatile memory device 120 or to read the data “DATA” stored in the non-volatile memory device 120.

The storage controller 110 may control the non-volatile memory device 120 to store the data “DATA” or to transfer the stored data “DATA” to the storage controller 110. The non-volatile memory device 120 may be a NAND flash memory device, but the present disclosure is not limited thereto. The non-volatile memory device 120 may include a first region R1, a second region R2, a third region R3, and a fourth region R4. Each of the first to fourth regions R1 to R4 may include a plurality of memory blocks. Each of the plurality of memory blocks may include a plurality of memory cells. Each memory block may include a plurality of physical pages of memory. A physical page of memory may comprise a plurality of memory cells (e.g., memory cell transistors) that are connected together and share a word line. A memory block may have all of its physical pages of memory erased together (e.g., simultaneously) in the same erase operation. A memory block may constitute the minimal unit of erase in the non-volatile memory device 120 (i.e., it may not be possible to erase physical pages or other portions of a memory block without erasing the entire memory block).

The number of bits stored in each memory cell of the first region R1 may be equal to the number of bits stored in each memory cell of the second region R2, and the number of bits stored in each memory cell of the third region R3 and the number of bits stored in each memory cell of the fourth region R4 may be different. Alternatively, the number of bits stored in each memory cell of the third region R3 may be equal to the number of bits stored in each memory cell of the fourth region R4.

Each of the plurality of memory cells included in the first region R1 and the second region R2 may be a single level cell (SLC) storing one bit. Each of the plurality of memory cells included in the third region R3 and the fourth region R4 may be a triple level cell (TLC) storing three bits. Because each memory cell of the first region R1 and the second region R2 is single level cell (SLC), the first region R1 and the second region R2 may be referred to as an SLC region, and because each memory cell of the third region R3 and the fourth region R4 is triple level cell (TLC), the third region R3 and the fourth region R4 may be referred to as a TLC region. Therefore, the first region R1 and the second region R2 may include memory blocks with the same cell type (e.g., an SLC type), and the third region R3 and the fourth region R4 may include memory blocks with the same cell type (e.g., a TLC type). For example, each memory cell in the first region R1 and the second region R2 stores m-bit data, and each memory cell in the third region R3 and the fourth region R4 stores n-bit data, and m and n are natural numbers and different from each other.

Therefore, each of the plurality of memory cells included in the first region R1 and the second region R2 may be configured to store two or more bits. Likewise, each of the plurality of memory cells included in the third region R3 and the fourth region R4 may be configured to store two bits, four bits or more than four bits.

According to an embodiment, the SLC region and the TLC region may be distinguished based on a partition boundary PB, and the partition boundary PB may be adjusted by PB information. The PB information may also be referred to as first boundary information. The first region R1 and the second region R2 may be distinguished based on an SLC remap boundary SRB, and the SLC remap boundary SRB may be adjusted by SRB information. The SRB information may also be referred to as second boundary information. The third region R3 and the fourth region R4 may be distinguished based on a TLC remap boundary TRB, the TLC remap boundary TRB may be adjusted by TRB information. The TRB information may also be referred to as third boundary information.

The non-volatile memory device 120 may be an automotive memory device for a vehicle, in which the non-volatile memory device 120 may include a first namespace (or partition) composed of SLC-type memory blocks and a second namespace (or partition) composed of TLC-type memory blocks. The SLC region may correspond to the first namespace, and the TLC region may correspond to the second namespace. The storage controller 110 may control the non-volatile memory device 120 in units of namespace. A namespace/partition may comprise a plurality of memory blocks that correspond to (i.e., identified by) a range of physical addresses (i.e., all physical addresses within the range). The memory blocks of a namespace / partition may be clustered together in a contiguous region of the non-volatile memory device, and in some examples, the memory blocks of a namespace may be the only memory blocks within an area of the non-volatile memory device 120. For example, the storage controller 110 may perform the reliability management operation, such as garbage collection or wear leveling, in units of pages or memory blocks in the corresponding namespace. In an embodiment, the partition boundary PB may be used to distinguish the SLC region and the TLC region. Therefore, the partition boundary PB may be used to distinguish between the first namespace and the second namespace.

According to an embodiment, the memory blocks of the first region R1 may be reserved blocks for replacing a bad block of the second region R2. The memory blocks of the second region R2 may store user data. The memory blocks of the second region R2 may be user memory blocks that store user data. User data may be distinguished from system data or meta data in that system data or meta data may refer to the information used by the operating system, applications, and hardware to manage functionality, performance, and security. The SLC remap boundary SRB may be used to distinguish a reserved region (i.e., the first region R1) including reserved blocks and a user region (i.e., the second region R2) including user memory blocks in which the user data are stored in the SLC region.

The memory blocks of the fourth region R4 may be reserved blocks for replacing a bad block of the third region R3. The memory blocks of the third region R3 may store user data. The memory blocks of the third region R3 may be user memory blocks. The TLC remap boundary TRB may be used to distinguish a reserved region (i.e., the fourth region R4) including reserved blocks and a user region (i.e., the third region R3) including user memory blocks in which the user data are stored in the TLC region.

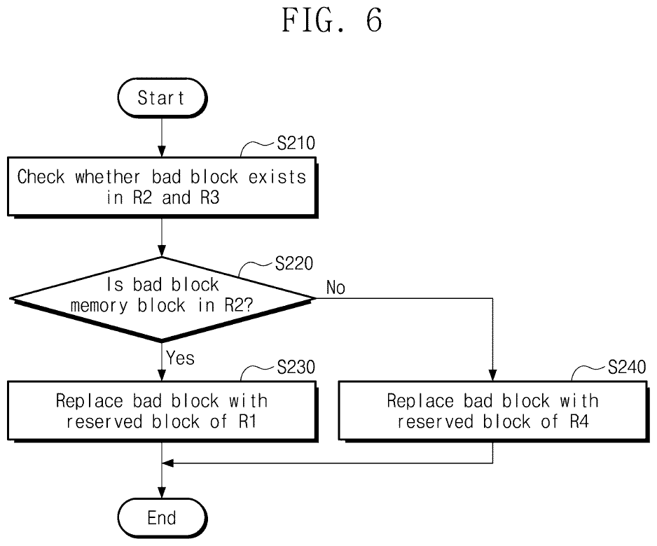

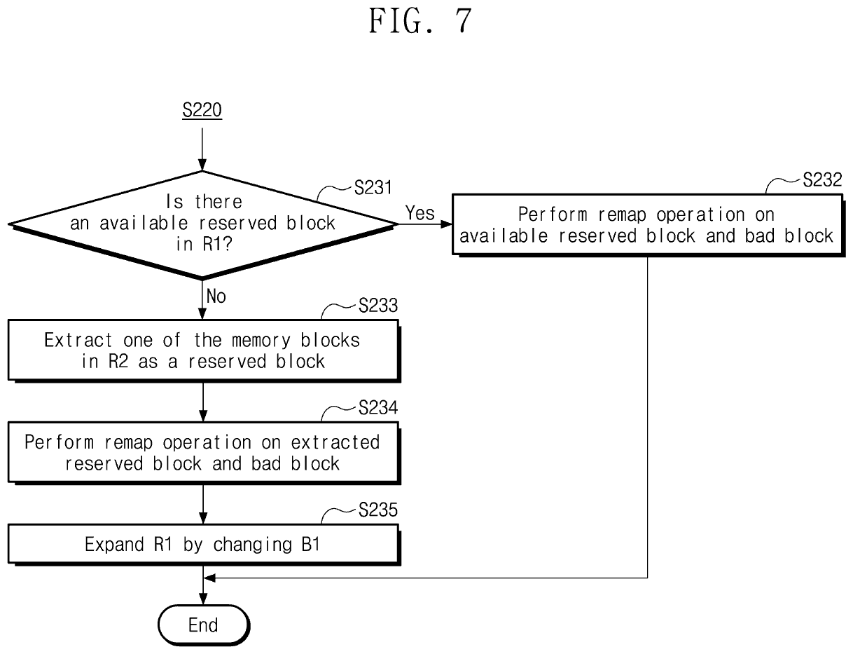

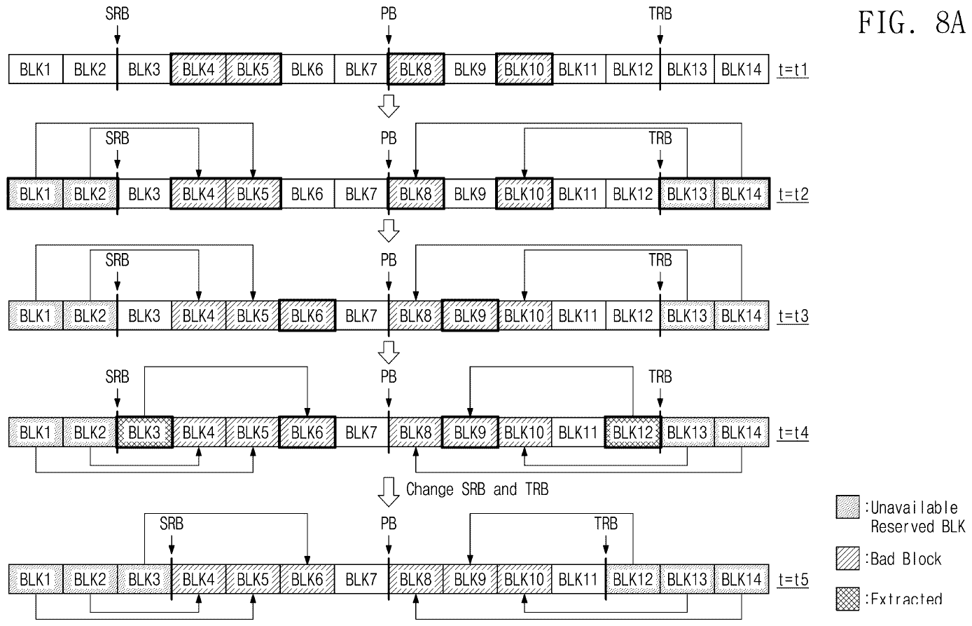

The storage controller 110 may set initial PB information to determine a location of the partition boundary PB in response to a set partition request from the external host device. Accordingly, the storage controller 110 may allocate some of the memory blocks of the non-volatile memory device 120 to the SLC region and the other memory blocks to the TLC region based on the initial PB information. After setting the initial PB information, the storage controller 110 may set initial SRB information and initial TRB information to determine locations of the SLC remap boundary SRB and the TLC remap boundary TRB. Accordingly, the storage controller 110 may allocate some of the memory blocks of the SLC region to the first region R1 and may allocate the other memory blocks of the SLC region to the second region R2. Likewise, the storage controller 110 may allocate some of the memory blocks of the TLC region to the third region R3 and may allocate the other memory blocks of the TLC region to the fourth region R4. The allocating operation of the storage controller 110 will be described in detail with reference to FIGS. 5A to 5C.

According to an embodiment, the storage controller 110 may include a bad block manager 111. The bad block manager 111 may be configured to manage bad blocks of the second region R2 and the third region R3. More specifically, the bad block manager 111 may replace a bad block of the second region R2 with a reserved block of the first region R1, and may replace a bad block of the third region R3 with a reserved block of the fourth region R4. Therefore, the bad block manager 111 may replace a bad block of the SLC region only with a reserved block of the SLC region and may replace a bad block of the TLC region only with a reserved block of the TLC region. For example, the first reserved blocks of the first region R1 may replace any bad block of the second region R2, but may not be used to replace bad blocks outside the second region, such as those of the third region.

The bad block may include an initial bad block which is generated during manufacturing process of the storage device 100 and a runtime bad block which is developed while driving the storage device 100.

Because memory cells of the TLC regions are programmed to have eight different threshold voltage levels whereas memory cells of the SLC region are programmed to have two different threshold voltage levels, the lifetime of the memory block of the TLC region may be shorter than the lifetime of the memory block of the SLC region. According to a related art, the bad block manager 111 may replace a bad block of the SLC region (e.g., a bad block of the second region R2) with a reserved block of the TLC region (e.g., a reserved block of the fourth region R4). Because the reserved block of the TLC region (e.g., the reserved block of the fourth region R4) may be used to replace the bad block of the SLC region (e.g., the bad block of the second region R2), the reserved block of the TLC region replacing the bad block of the SLC region may have weaker endurance characteristics than the reserved block of the SLC region (e.g., the reserved block of the first region R1) replacing the bad block of the SLC region. Therefore, when the reserved block of the SLC region (e.g., the reserved block of the first region R1) and the reserved block of the TLC region (e.g., the reserved block of the fourth region R4) are interchangeably used to replace a bad block, the lifetime of the storage device 100 may be shortened, and the reliability of data stored in the storage device 100 may be reduced.

According to an embodiment of the present disclosure, the bad block manager 111 may replace the bad block of the SLC region only with the reserved block of the SLC region, and may replace the bad block of the TLC region only with the reserved block of the TLC region. Accordingly, the bad block manager 111 may not use the reserved block of the SLC region to replace the bad block of the TLC region, and may not use the reserved block of the TLC region to replace the bad block of the SLC region. Accordingly, the performance of the storage device 100 may be improved.

The bad block manager 111 may be further configured to change the SRB information and the TRB information to manage the SLC remap boundary SRB and the TLC remap boundary TRB. For example, when all of the reserved blocks of the first region R1 are used to replace the bad blocks of the second region R2, the bad block manager 111 may change the SRB information to expand the first region R1 by shifting the SLC remap boundary SRB in a direction to increase the number of reserved blocks in the first region R1 and to decrease the number of user memory blocks in the second region R2. The bad block manager 111 may change the SLC remap boundary SRB to reallocate at least one memory block of the second region R2 to the first region R1. Accordingly, the first region R1 may be expanded, and the number of memory blocks in the first region R1 may be increased. Alternatively, when a number of reserved blocks of the first region R1 available to replace the bad blocks of the second region R2 becomes smaller than a predetermined number, the bad block manager 111 may change the SRB information to expand the first region R1.

When all of the reserved blocks of the fourth region R4 are used to replace the bad blocks of the third region R3, the bad block manager 111 may change the TRB information to expand the fourth region R4 by shifting the TLC remap boundary TRB in a direction to increase the number of reserved blocks in the fourth region R4 and to decrease the number of user memory blocks in the third region R3. The bad block manager 111 may change the TRB information to reallocate at least one memory block of the third region R3 to the fourth region R4. Accordingly, the fourth region R4 may be expanded, and the number of memory blocks in the fourth region R4 may be increased. Alternatively, when a number of reserved blocks of the fourth region R4 available to replace the bad blocks of the third region R3 becomes smaller than a predetermined number, the bad block manager 111 may change the TRB information to expand the fourth region R4. Therefore, when the reserved blocks of the first region R1 or the reserved blocks of the fourth region R4 are exhausted, the bad block manager 111 may change the SRB information or the TRB information to obtain additional reserved blocks.

According to an embodiment, the storage controller 110 may include a partition manager 112. The partition manager 112 may manage the PB information to adjust the partition boundary PB. More specifically, the partition manager 112 may set an initial PB information to determine a location of the partition boundary PB in response to the set partition request from the external host device. After the initial setting of the PB information, the partition manager 112 may receive a re-partitioning request from the external host device, and may perform a re-partitioning operation by changing the PB information to adjust the partition boundary PB.

According to a related art, when the partition boundary PB is changed by the re-partitioning operation, the SLC remap boundary SRB and the TLC remap boundary TRB may also be changed depending on the changed partition boundary. Therefore, whenever the re-partitioning operation is performed, the bad block manager 111 may change the mapping information with respect to bad blocks of the second region R2 and reserved blocks of the first region R1, where the reserved blocks of the first region R1 are used to replace the bad blocks of the second region R2. Likewise, whenever the re-partitioning operation is performed, the bad block manager 111 may change the mapping information with respect to bad blocks of the third region R3 and reserved blocks of the fourth region R4, where the reserved blocks of the fourth region R4 are used to replace the bad blocks of the third region R3.

According to an embodiment of the present disclosure, because the first region R1 to the fourth region R4 are sequentially disposed, the first region R1 may be adjacent to the second region R2, the second region R2 may be adjacent to the third region R3, the third region R3 may be adjacent to the fourth region R4, and the fourth region R4 may not be adjacent to the first region R1. Accordingly, even though the PB information is changed by the re-partitioning operation, the SLC remap boundary SRB and the TLC remap boundary TRB may not be changed. Accordingly, even when PB information is changed and the partition boundary PB is adjusted, the bad block manager 111 may not change the mapping information with respect to the bad blocks of the second region R2 and the reserved blocks of the first region R1, and may not change the mapping information with respect to the bad blocks of the third region R3 and the reserved blocks of the fourth region R4. Because the bad block manager 111 may not change the SRB information and the TRB information, even when the partition boundary PB is changed, the bad block manager 111 may manage bad blocks of the non-volatile memory device 120 more efficiently.

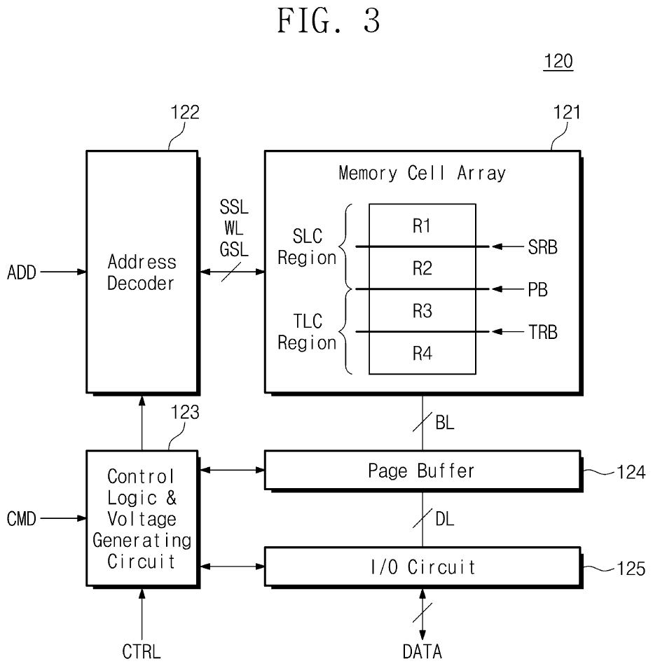

FIG. 2 is a block diagram for describing a storage controller of FIG. 1. Referring to FIG. 2, the storage controller 110 may include the bad block manager 111, the partition manager 112, a processor 113, a buffer memory 114, a bad block mapping table 115, a boundary information table 116, a flash translation layer (FTL) 117, a host interface circuit 118, and a non-volatile memory interface circuit 119.

The bad block manager 111, the partition manager 112, the processor 113, the buffer memory 114, the bad block mapping table 115, the boundary information table 116, the FTL 117, the host interface circuit 118, and the non-volatile memory interface circuit 19 may be connected to each other through a bus.

The operations of the bad block manager 111 and the partition manager 112 are described with reference to FIG. 1. Each of the bad block manager 111 and the partition manager 112 may be a hardware circuit or a functional module formed as software that configures the processor 113 or other processor(s) of the storage controller 111.

The processor 113 may control overall operations of the storage controller 110. For example, the processor 113 may execute an operating system or firmware for driving the storage controller 110. The processor 113 may generate the addresses ADD and the commands CMD for controlling the non-volatile memory device 120, based on a request from a host device HOST.

The buffer memory 114 may be configured to store information necessary for the storage controller 110 to control the non-volatile memory device 120 and to communicate with the host device HOST. For example, the buffer memory 114 may temporarily store data to be stored in the non-volatile memory device 120 or data read from the non-volatile memory device 120. The buffer memory 114 may be implemented with a static random access memory (SRAM), a dynamic random access memory (DRAM), or other volatile memory device. According to an embodiment, the buffer memory 114 may be configured to store the bad block mapping table 115, the boundary information table 116 and FTL. In other examples, the bad block mapping table 115, the boundary information table 116 and FTL 117 may be stored in one or more memories (SRAM, DRAM, etc.) other than the buffer memory 114.

The bad block mapping table 115 may include mapping information related to bad blocks of the second region R2 and reserved blocks of the first region R1. The bad block mapping table 115 may further include mapping information related to bad blocks of the third region R3 and reserved blocks of the fourth region R4. More particularly, the bad block mapping table 115 may include an SLC mapping table SMT and a TLC mapping table TMT. The SLC mapping table SMT may include mapping information related to bad blocks of the second region R2 and reserved blocks of the first region R1 used to replace the bad blocks. The TLC mapping table TMT include mapping information related to bad blocks of the third region R3 and reserved blocks of the fourth region R4 used to replace the bad blocks. The bad block manager 111 may manage the bad block mapping table 115. The bad block manager 111 may manage bad blocks of the second region R2 based on the SLC mapping table SMT and may manage bad blocks of the third region R3 based on the TLC mapping table TMT.

The boundary information table 116 may include the SRB information, the PB information, and the TRB information. The SRB information indicates location of the SLC remap boundary SRB. The PB information indicates location of the partition boundary PB. The TRB information indicates location of the TLC remap boundary TRB. According to an embodiment, the bad block manager 111 may manage the SRB information and the TRB information of the boundary information table 116, and the partition manager 112 may manage the PB information of the boundary information table 116.

The FTL 117 may translate a logical address received from the host device HOST to a physical address used in the non-volatile memory device 120. Additionally, the FTL 117 may perform the reliability management operations for the non-volatile memory device 120. The reliability management operations may include operations such as wear leveling and garbage collection. The FTL may be a hardware circuit or a functional module formed as software that configures the processor 113 or another processor of the storage controller 110. The FTL may also include one or more data tables (e.g., an address translation table) that may be part of buffer memory 114 or a separate memory.

The FTL 117 may independently perform the reliability management operations for the SLC region (e.g., the first region R1 and the second region R2) and the reliability management operations for the TLC region (e.g., the third region R3 and the fourth region R4). The FTL 117 may include the bad block manager 111 and the partition manager 112, and the bad block manager 111 and the partition manager 112 which are configured to perform the bad block management and the partition management, respectively.

The storage controller 110 may communicate with the host device HOST through the host interface circuit 118. The host interface circuit 118 may provide a host interface layer (HIL). The host interface circuit 118 may be implemented based on at least one of interfaces such as a serial ATA (SATA) interface, a peripheral component interconnect express (PCIe) interface, a serial attached SCSI (SAS), a non-volatile memory express (NVMe) interface, and a universal flash storage (UFS) interface.

The storage controller 110 may communicate with the non-volatile memory device 120 through the non-volatile memory interface circuit 119. In some embodiments, the non-volatile memory interface circuit 119 may be implemented based on the NAND interface.

The storage controller 110 illustrated in FIG. 2 is provided as an example, and the present disclosure is not limited thereto. The storage controller 110 may further include various other components such as an error correction code (ECC) engine, a randomizer, and a buffer management circuit.

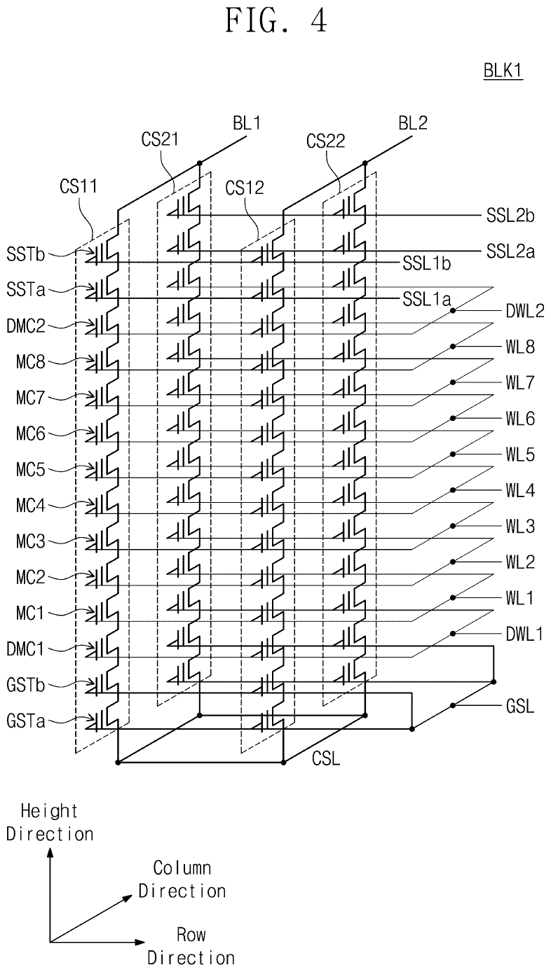

FIG. 3 is a block diagram illustrating a non-volatile memory device of FIG. 1. Referring to FIGS. 1 and 3, the non-volatile memory device 120 may include a memory cell array 121, an address decoder 122, a control logic and voltage generating circuit 123, a page buffer circuit 124, and an input/output circuit 125.

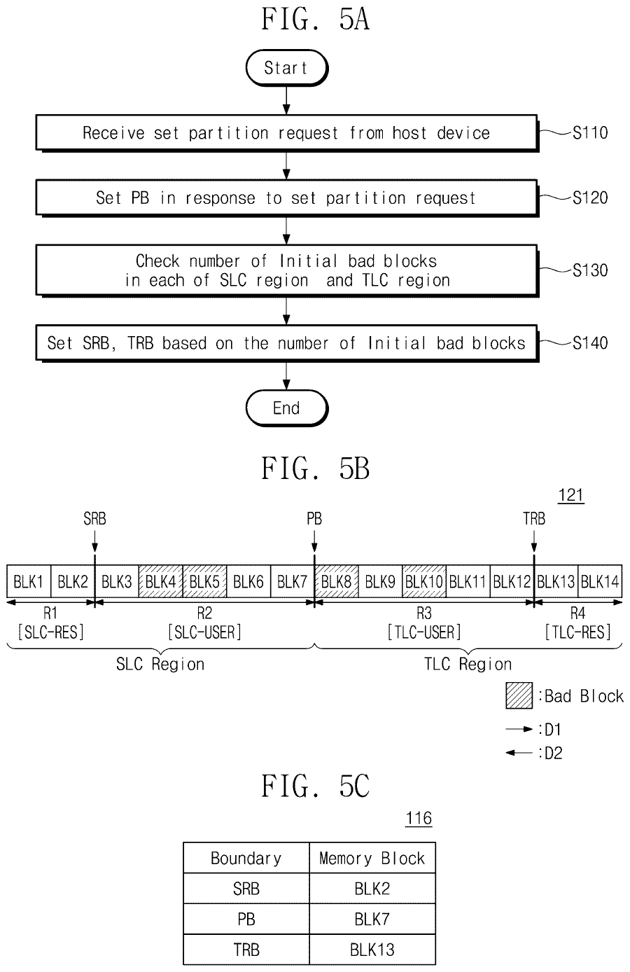

The memory cell array 121 may include the first to fourth regions R1 to R4. The first region R1 and the second region R2 may be distinguished based on the SLC remap boundary SRB, the second region R2 and the third region R3 may be distinguished based on the partition boundary PB, and the third region R3 and the fourth region R4 may be distinguished based on the TLC remap boundary TRB. Each of the first to fourth regions R1 to R4 may include a plurality of memory blocks. Each of the plurality of memory blocks may include a plurality of cell strings, and each of the plurality of cell strings may include a plurality of cell transistors. The plurality of cell transistors may be connected in series between bit lines BL and a common source line CSL and may be connected to string selection lines SSL, word lines WL, and ground selection lines GSL. Each of the plurality of memory blocks will be described in detail with reference to FIG. 4.

The address decoder 122 may be connected to the memory cell array 121 through the string selection lines SSL, the word lines WL, and the ground selection lines GSL. The address decoder 122 may receive the address ADD from the storage controller 110 and may decode the received address ADD. The address decoder 122 may control voltages of the string selection lines SSL, the word lines WL, and the ground selection lines GSL based on the decoding result.

The control logic and voltage generating circuit (hereinafter referred to as a “control logic circuit”) 123 may control various components of the nonvolatile memory device 120 in response to signals (e.g., a command CMD and a control logic CTRL) received from the storage controller 110.

The control logic circuit 123 may generate various operating voltages necessary for the nonvolatile memory device 120 to operate. For example, the control logic circuit 123 may generate a plurality of program voltages, a plurality of pass voltages, a plurality of verify voltages, a plurality of read voltages, a plurality of non-selection read voltages, a plurality of erase voltages, and a plurality of erase verify voltages.

The page buffer circuit 124 may be connected with the memory cell array 121 through the bit lines BL. The page buffer circuit 124 may be configured to read data stored in the memory cell array 121 by sensing voltage changes of the bit lines BL. The page buffer circuit 124 may be further configured to write data in the memory cell array 121 by controlling voltages of the bit lines BL. The page buffer circuit include registers to temporarily store data to be written in the memory cell array 121 or read out from the memory cell. The maximum number of registers included in the page buffer may corresponds to the maximum number of data bits in a memory cell. For example, when the maximum number of data bits in the memory cell is three (i.e., the memory cell is TLC), the maximum number of registers in the page buffer is three. The number of registers used for read or write operation may be different depending on the memory cell types to which the page buffer is connected during the read or write operation. For example, when the page buffer is connected to the SLC, one register in the page buffer may be used to temporarily store one bit data of the SLC. On the other hand, when the page buffer is connected to the TLC, three registers in the page buffer may be used to temporarily store three bits data of the TLC.

The input/output circuit 125 may receive the data “DATA” from the storage controller 110 and may provide the received data “DATA” to the page buffer circuit 124. The input/output circuit 125 may receive the data “DATA” from the page buffer circuit 124 and may provide the received data “DATA” to the storage controller 110.

FIG. 4 is a circuit diagram illustrating a first memory block included in a memory cell array of FIG. 3. A memory block of a three-dimensional structure will be described with reference to FIG. 4, but the present disclosure is not limited thereto. A memory block according to the present disclosure may have a two-dimensional memory block structure. A first memory block BLK1 will be described with reference to FIG. 4, but the scope and spirit of the present disclosure is not limited thereto. The remaining memory blocks may be similar in structure to the first memory block BLK1 to be described with reference to FIG. 4.

In an embodiment, the first memory block BLK1 described with reference to FIG. 4 may correspond to a physical erase unit of the memory device 120. However, the present disclosure is not limited thereto. For example, the nonvolatile memory device 1220 may perform the erase operation in units of page, word line, sub-block, or plane.

Referring to FIGS. 3 and 4, the first memory block BLK1 may include a plurality of cell strings CS11, CS12, CS21, and CS22. The plurality of cell strings CS11, CS12, CS21, and CS22 may be arranged in a row direction and a column direction to form rows and columns.

Each of the plurality of cell strings CS11, CS12, CS21, and CS22 includes a plurality of cell transistors. For example, each of the cell strings CS11, CS12, CS21, and CS22 may include string selection transistors SSTa and SSTb, a plurality of memory cells MC1 to MC8, ground selection transistors GSTa and GSTb, and dummy memory cells DMC1 and DMC2. Each of a plurality of cell transistors included in the cell strings CS11, CS12, CS21, and CS22 may be a charge trap flash (CTF) memory cell.

In each cell string, the plurality of memory cells MC1 to MC8 are serially connected and are stacked in a height direction that is a direction perpendicular to a plane defined by the row direction and the column direction or to a substrate. In each cell string, the string selection transistors SSTa and SSTb are serially connected and are interposed between a bit line BL1 or BL2 and the plurality of memory cells MC1 to MC8. In each cell string, the ground selection transistors GSTa and GSTb are connected in series between the plurality of memory cells MC1 to MC8 and a common source line CSL.

Each cell string may include the first dummy memory cell DMC1 disposed between the plurality of memory cells MC1 to MC8 and the ground selection transistors GSTa and GSTb, and the second dummy memory cell DMC2 disposed between the string selection transistors SSTa and SSTb and the plurality of memory cells MC1 to MC8.

The ground selection transistors GSTa and GSTb may be connected to the same ground selection line GSL. However, the present disclosure is not limited thereto. Ground selection transistors coupled to the same row, among the ground selection transistors GSTa or GSTb placed at the same height, may be connected to the same ground selection line, and ground selection transistors coupled to another row, among the ground selection transistors GSTa or GSTb placed at the same height, may be connected to another ground selection line. Alternatively, ground selection transistors at same heights may be connected to the same ground selection line. Alternatively, ground selection transistors coupled to at least two rows, among ground selection transistors placed at the same height, may be connected to the same ground selection line, and ground selection transistors coupled to at least two other rows, among the ground selection transistors placed at the same height, may be connected to another ground selection line. Alternatively, ground selection transistors placed at different heights may be connected to the same ground selection line. A connection relationship between the ground selection transistors GSTa and GSTb and the ground selection line GSL may be changed and modified differently based on a structure of the memory block.

Memory cells of the same height from the substrate or the ground selection transistors GSTa and GSTb may be connected in common to the same word line, and memory cells of different heights therefrom may be connected to different word lines. For example, each memory cell of the memory cells MC1 to MC8 of the cell strings CS11, CS12, CS21, and CS22 may be connected with corresponding word line of the first to eighth word lines WL1 to WL8.

String selection transistors in the same row, among the first string selection transistors SSTa placed at the same height, are connected to the same string selection line, and string selection transistors in another row, among the first string selection transistors SSTa placed at the same height, are connected to another string selection line. For example, the first string selection transistors SSTa of the cell strings CS11 and CS12 in the first row are connected in common to a string selection line SSL1a, and the first string selection transistors SSTa of the cell strings CS21 and CS22 in the second row are connected in common to a string selection line SSL2a.

Likewise, string selection transistors in the same row, among the second string selection transistors SSTb placed at the same height, are connected to the same string selection line, and string selection transistors in another row, among the second string selection transistors SSTb placed at the same height, are connected to another string selection line. For example, the second selection transistors SSTb of the cell strings CS11 and CS12 in the first row are connected in common to a string selection line SSL1b, and the second string selection transistors SSTb of the cell strings CS21 and CS22 in the second row are connected in common to a string selection line SSL2b.

In an embodiment, dummy memory cells placed at the same height are connected to the same dummy word line, and dummy memory cells placed at different heights are connected with different dummy word lines. For example, the first dummy memory cells DMC1 are connected to a first dummy word line DWL1, and the second dummy memory cells DMC2 are connected to a second dummy word line DWL2.

According to an embodiment, a first erase control transistor may be disposed between the ground selection transistors GSTa and GSTb and the common source line CSL. A second erase control transistor may be provided between the bit line BL1 or BL2 and the string selection transistors SSTa and SSTb. The first and second erase control transistors may be controlled to charge channels of the cell strings CS11, CS12, CS21, and CS22 with an erase voltage or to erase the first memory block BLK1, based on a gate induced drain leakage (GIDL) phenomenon. The first erase control transistors of the cell strings CS11, CS12, CS21, and CS22 may be connected in common to a first erase control line. The second erase control transistors of the cell strings CS11, CS12, CS21, and CS22 may be connected in common to a second erase control line. However, the present disclosure is not limited thereto. For example, the first and second erase control transistors of the cell strings CS11, CS12, CS21, and CS22 may be connected to different erase control lines in different manners.

The first memory block BLK1 illustrated in FIG. 4 is illustrated only as an example. The number of cell strings may increase or decrease, and the number of rows of cell strings and the number of columns of cell strings may increase or decrease depending on the number of cell strings. Also, the number of cell transistors GST, MC, DMC, and SST of the first memory block BLK1 may increase or decrease, and the height of the first memory block BLK1 may increase or decrease depending on the number of cell transistors. In addition, the number of lines GSL, WL, DWL, and SSL connected to the cell transistors may increase or decrease depending on the number of cell transistors.

FIG. 5A is a flowchart for describing an operation of a storage controller performing initial allocation of memory blocks to first to fourth regions of a memory cell array of FIG. 3. FIG. 5B is a diagram for describing regions included in a memory cell array of FIG. 3 after initial allocation is performed. FIG. 5C is a diagram for describing a boundary information table after initial allocation is performed.

Referring to FIG. 5A, in operation S110, the storage controller 110 may receive the set partition request from the external host device. The set partition request may include capacity information requested by the host device. The capacity information may indicate a ratio (hereinafter referred to “a capacity ratio of the SLC region”) of a capacity occupied by the SLC region to a capacity of the non-volatile memory device 120. The set partition request may be included in a “Set Feature” command, or a “Set Feature” request from the external host device.

In operation S120, the storage controller 110 may set the partition boundary PB in response to the set partition request. More particularly, the partition manager 112 may allocate memory blocks corresponding to the capacity ratio of the SLC region among the memory blocks of the non-volatile memory device 120 to the SLC region and may allocate the remaining memory blocks to the TLC region.

Referring to FIG. 5B, the memory cell array 121 may include first to fourteenth memory blocks BLK1 to BLK14. Each of the first to fourteenth memory blocks BLK1 to BLK14 may be similar in structure to the first memory block BLK1 described with reference to FIG. 4. However, the present disclosure is not limited thereto. Although the memory cell array 121 is illustrated to include fourteen memory blocks BLK1 to BLK14, but the present disclosure is not limited thereto. For example, the number of memory blocks may be different depending on the size of the memory cell array 121. Physical addresses corresponding to memory blocks may be incremented in an order from the first memory block BLK1 to the fourteenth memory block BLK14.

For example, when the set partition request may include information indicating that the capacity ratio of the SLC region in the non-volatile memory device 120 is 50%, the partition manager 112 may allocate 50% of the first to fourteenth memory blocks BLK1 to BLK14 to the SLC region. The partition manager 112 may prioritize the allocation of memory blocks with lower physical addresses to the SLC region first. For example, the partition manager 112 may allocate the first to seventh memory blocks BLK1 to BLK7 among the first to fourteenth memory blocks BLK1 to BLK14 to the SLC region.

The partition manager 112 may allocate the remaining memory blocks BLK8 to BLK14 to the TLC region, and may locate the partition boundary PB between the seventh memory block BLK7 and the eighth memory block BLK8. As a result of the partitioning, the memory cells of the memory blocks BLK1 to BLK7 may be included in the SLC region, and may function as single level cells (SLC), and the memory cells of the memory blocks BLK8 to BLK14 may be included in the TLC region, and may function as triple level cells (TLC).

Referring to FIG. 5C, the partition manager 112 may store partition boundary information, also referred to as PB information, in the boundary information table 116. For example, the partition manager 112 may store the PB information which indicates a memory block with the highest physical address among the memory blocks in the SLC region (e.g., the seventh memory block BLK7). The partition manager 112, based on the PB information, may allocate the seventh memory block BLK7 and other memory blocks with lower physical addresses BLK1 to BLK6 to the SLC region. Therefore, the memory blocks BLK1 to BLK7 may be allocated to the SLC region.

The bad block manager 111 may check that the partition boundary PB is located between the seventh memory block BLK7 and the eighth memory block BLK8, by referring to the boundary information table 116, and may allocate the memory blocks BLK1 to BLK7 among the memory blocks BLK1 to BLK14 of the memory cell array 121 to the SLC region and the memory blocks BLK8 to BLK14 to the TLC region.

Referring to FIG. 5A, in operation S130, the storage controller 110 may check the number of initial bad blocks of each of the SLC region and the TLC region. Referring to FIG. 5B, for example, the fourth memory block BLK4 and the fifth memory block BLK5 among the memory blocks BLK1 to BLK7 of the SLC region may be initial bad blocks. The bad block manager 111 may check that the number of initial bad blocks of the SLC region is two. Additionally, the eighth memory block BLK8 and the tenth memory block BLK10 among the memory blocks BLK8 to BLK14 of the TLC region may be initial bad blocks. The bad block manager 111 may check that the number of initial bad blocks of the TLC region is two.

In operation S140 of FIG. 5A, the storage controller 110 may set the SRB information which indicates the SLC remap boundary SRB, and the TRB information which indicates the TLC remap boundary TRB based on the number of initial bad blocks. The bad block manager 111 may set the SRB information based on the number of initial bad blocks of the SLC region. The reserved region (i.e., the first region R1) and the user region (i.e., the second region R2) of the SLC region may be distinguished by the SLC remap boundary SRB based on the SRB information. For example, the bad block manager 111 may set the SRB information such that the reserved region (i.e., the first region R1) of the SLC region includes a number of reserved blocks which is equal to or greater than the number of initial bad blocks of the user region (i.e., the second region R2) of the SLC region. The bad block manager 111 may set the TRB information based on the number of initial bad blocks of the TLC region. The reserved region (i.e., the fourth region R4) and the user region (i.e., the third region R3) of the TLC region may be distinguished by the TLC remap boundary TRB based on the TRB information. For example, the bad block manager 111 may set the TRB information such that the reserved region (i.e., the fourth region R4) of the TLC region includes a number of reserved blocks which is equal to or greater than the number of initial bad blocks of the user region (i.e., the third region R3) of the TLC region.

Referring to FIG. 5B, because the number of initial bad blocks of the SLC region is two, the bad block manager 111 may allocate the memory blocks BLK1 and BLK2 with lower physical addresses among the memory blocks BLK1 to BLK7 of the SLC region to the first region R1 and may allocate the remaining memory blocks BLK3 to BLK7 of the SLC region to the second region R2. Accordingly, the bad block manager 111 may set the SRB information for the SLC remap boundary SRB to be located between the second memory block BLK2 and the third memory block BLK3. Therefore, the memory blocks BLK1 and BLK2 of the first region R1 may be used as reserved blocks for replacing bad blocks of the second region R2. Also, the user data may be stored in the memory blocks BLK3 to BLK7 of the second region R2. Because the bad block manager 111 sets the SRB information for the SLC remap boundary SRB to be located between an SLC reserved region SLC-RES and an SLC user region SLC-USER, the SLC reserved region SLC-RES and the SLC user region SLC-USER may be distinguished in the SLC region by the SLC remap boundary SRB.

Likewise, because the number of initial bad blocks of the TLC region is two, the bad block manager 111 may allocate the memory blocks BLK13 and BLK14 with upper physical addresses among the memory blocks BLK8 to BLK14 of the TLC region to the fourth region R4 and may allocate the remaining memory blocks BLK8 to BLK12 of the TLC region to the third region R3. Accordingly, the bad block manager 111 may set the TRB information for the TLC remap boundary TRB to be located between the twelfth memory block BLK12 and the thirteenth memory block BLK13. Therefore, the memory blocks BLK13 and BLK14 of the fourth region R4 may be used as reserved blocks for replacing bad blocks of the third region R3. Also, the user data may be stored in the memory blocks BLK8 to BLK12 of the third region R3. Because the bad block manager 111 sets the TRB information for the TLC remap boundary TRB to be located between a TLC reserved region TLC-RES and a TLC user region TLC-USER, the TLC reserved region TLC-RES and the TLC user region TLC-USER may be distinguished in the TLC region by the TLC remap boundary TRB.

The second region R2 may store data which are frequently updated, and the third region R3 may store normal data used by the user. For example, the second region R2 may store firmware data such as a file system, while the third region R3 may store user data such as texts, images, audio files or video files.

According to an embodiment, when all the reserved blocks of the first region R1 are exhausted, the bad block manager 111 may obtain an additional reserved block of the first region R1 by shifting the SLC remap boundary SRB in a direction (e.g., a first direction D1) from the first region R1 to the second region R2. Likewise, when all the reserved blocks of the fourth region R4 are exhausted, the bad block manager 111 may obtain an additional reserved block of the fourth region R4 by shifting the TLC remap boundary TRB in a direction (e.g., a second direction D2) from the fourth region R4 to the third region R3.

Referring to FIG. 5C, the bad block manager 111 may store the SRB information and the TRB information in the boundary information table 116. For example, the SRB information stored in the bad block manager 111 may indicate the memory block BLK2 with the highest physical address among the memory blocks BLK1 and BLK2 of the first region R1 as location information of the SLC remap boundary. The TLC TRB information stored in the bad block manager 111 may indicate the memory block BLK13 with the lowest physical address among the memory blocks BLK13 and BLK14 of the fourth region R4 as location information of the TLC remap boundary.

The storage controller 110, based on the SRB information in the boundary information table 116, may check that the memory blocks BLK1 and BLK2 are included in the first region R1 because physical addresses of the memory blocks BLK1 and BLK2 are the lowest among the memory blocks BLK1 to BLK7 of the SLC region.

The storage controller 110, based on the TRB information in the boundary information table 116, may check that the memory blocks BLK13 and BLK14 are included in the fourth region R4 because physical addresses of the memory blocks BLK13 and BLK14 are the highest among the memory blocks BLK8 to BLK14 of the TLC region.

The storage controller 110 may set initially the SRB information, the PB information, and the TRB information in response to the set partition request from the external host device. As a result of the initial setting of the SRB information, the PB information, and the TRB information, the storage controller 110 may allocate each of the memory blocks to one of the first to fourth regions R1 to R4.

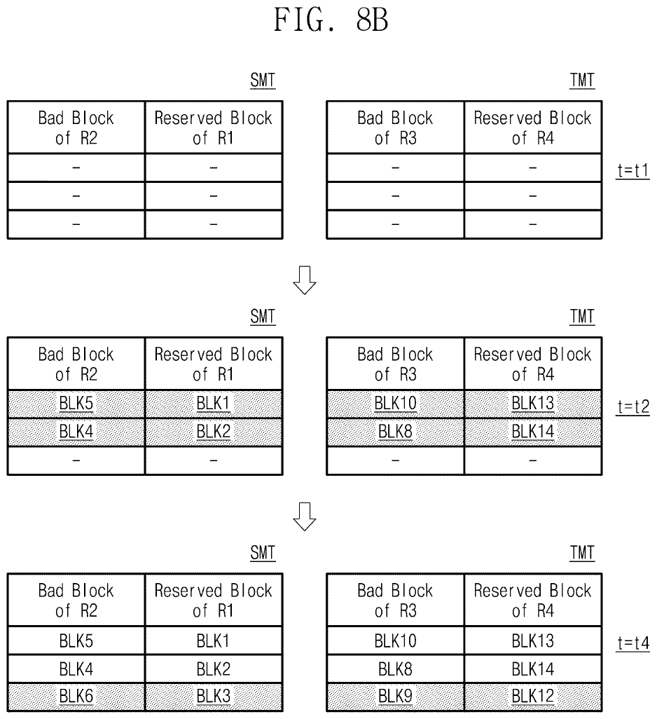

FIG. 6 is a flowchart for describing a bad block management method of a storage controller of FIG. 1. FIG. 6 will be described with reference to FIGS. 1, 2, and 5A to 5C. The bad block management operations of FIG. 6 may be performed after the initial allocation of the memory blocks BLK1 to BLK14 to the regions R1 to R4 of the memory cell array 121. Referring to FIG. 6, in operation S210, the storage controller 110 may check whether a bad block is developed in the second region R2 or the third region R3. For example, the bad block manager 111 may check whether bad blocks are present in the memory blocks BLK3 to BLK7 of the second region R2 or in the memory blocks BLK8 to BLK12 of the third region R3.

When a bad block is found either in the second region R2 or in the third region R3, in operation S220, the storage controller 110 may determine whether the bad block is a memory block of the second region R2 or a memory block of the third region R3. When the bad block is determined to be a memory block of the second region R2, the storage controller 110 may perform, in operation S230, replacing the bad block with a reserved block of the first region R1. When the bad block is not a memory block of the second region R2 (i.e., when a bad block is a memory block of the third region R3), the storage controller 110 may perform, in operation S240, replacing the bad block with a reserved block of the fourth region R4. For example, when one of the memory blocks BLK3 to BLK7 is checked as a bad block, the bad block manager 111 may determine that the checked bad block is present in the second region R2, and when one of the memory blocks BLK3 to BLK7 is checked as a bad block, the bad block manager 111 may determine that the checked bad block is present in the third region R3.

In operation S230, the storage controller 110 may replace the bad block with a reserved block of the first region R1. For example, the bad block manager 111 may remap the physical address of the bad block of the second region R2 to the physical address of the reserved block of the first region R1. Accordingly, when the bad block of the second region R2 is attempted to be accessed, the reserved block of the first region R1 is selected instead.

In operation S240, the storage controller 110 may replace the bad block with a reserved block of the fourth region R4. For example, the bad block manager 111 may remap the physical address of the bad block of the third region R3 to the physical address of the reserved block of the fourth region R4. Accordingly, when the bad block of the third region R3 is attempted to be accessed, the reserved block of the fourth region R4 is selected instead.

According to an embodiment of the present disclosure, the storage controller 110 may replace the bad block of the SLC region (e.g., the second region R2) with the reserved block of the SLC region (e.g., the first region R1) and may replace the bad block of the TLC region (e.g., the third region R3) with the reserved block of the TLC region (e.g., the fourth region R4). Accordingly, the storage controller 110 may not use the memory blocks of the SLC region (e.g., the first region R1) to replace the bad block of the TLC region (e.g., the third region R3) and may not use the memory blocks of the TLC region (e.g., the fourth region R4) to replace the bad block of the SLC region (e.g., the second region R2).

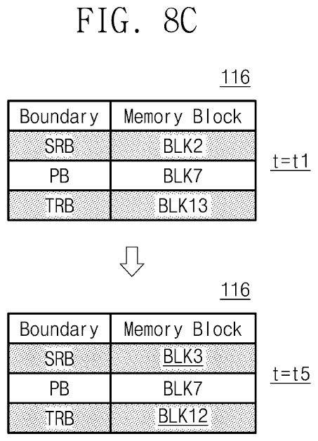

FIG. 7 is a flowchart for describing an operation of replacing a bad block with a reserved block of a first region in operation S230 of FIG. 6. Referring to FIG. 7, in operation S231, the storage controller 110 may determine whether an available reserved block is present in the first region R1. For example, the bad block manager 111 may determine whether an available reserved block is present in the first region R1, based on the SLC mapping table SMT and the boundary information table 116. The available reserved block may indicate a reserved block, which is not used to replace a bad block, among the reserved blocks. When the available reserved block is present in the first region R1, the storage controller 110 may perform operation S232. When the available reserved block is absent from the first region R1, the storage controller 110 may perform operation S233.

In operation S232, the storage controller 110 may remap the bad block of the second region R2 to the available reserved block of the first region R1, thereby replacing the bad block with the available reserved block. More specifically, the bad block manager 111 may remap the physical address of the bad block to the physical address of the available reserved block. The bad block manager 111 may update a mapping relationship between the available reserved block and the bad block in the SLC mapping table SMT. Accordingly, the bad block manager 111 may replace the bad block with the available reserved block.

In operation S233, the storage controller 110 may extract one of the memory blocks of the second region R2 as a reserved block. The bad block manager 111 may extract a memory block among the memory blocks of the second region R2 as a reserved block, in which the extracted memory block may be a memory block adjacent to the first region that is not a bad block.

In operation S234, the storage controller 110 may perform the remap operation on the extracted reserved block and the bad block. More particularly, the bad block manager 111 may remap the physical address of the bad block to the physical address of the extracted reserved block. The bad block manager 111 may update a mapping relationship between the extracted reserved block and the bad block in the SLC mapping table SMT. Accordingly, the bad block manager 111 may replace the bad block with the extracted reserved block.

In operation S235, the storage controller 110 may change the SRB information to expand the first region R1. By updating the SRB information in the boundary information table 116, the location of the SLC remap boundary SRB may be changed accordingly. The bad block manager 111 may change the SRB information such that the extracted reserved block is included in the first region R1. Accordingly, the bad block manager 111 may replace the bad block of the second region R2 with the reserved block of the first region R1.

According to an embodiment of the present disclosure, when all of the reserved blocks of the first region R1 for replacing bad blocks of the second region R2 are exhausted, the storage controller 110 may expand the first region R1 by including at least one of memory blocks of the second region R2 in the first region R1. Accordingly, the storage controller 110 may replace bad blocks of the SLC region with memory blocks of the SLC region.

Likewise, the storage controller 110 may perform operation S240 of FIG. 6 in a manner similar to operation S230. The storage controller 110 may determine whether an available reserved block is present in the fourth region R4. When an available reserved block for replacing a bad block of the third region R3 is present in the fourth region R4, the storage controller 110 may perform the remap operation on the available reserved block and the bad block to replace the bad block with the reserved block of the fourth region R4. When an available reserved block for replacing a bad block of the third region R3 is absent from the fourth region R4, the storage controller 110 may replace a bad block of the third region R3 with a reserved block of the fourth region R4 by extracting one of the memory blocks of the third region R3 as a reserved block, performing the remap operation on the extracted reserved block and the bad block, and changing the TRB information to adjust the TLC remap boundary in a direction to expand the fourth region R4.

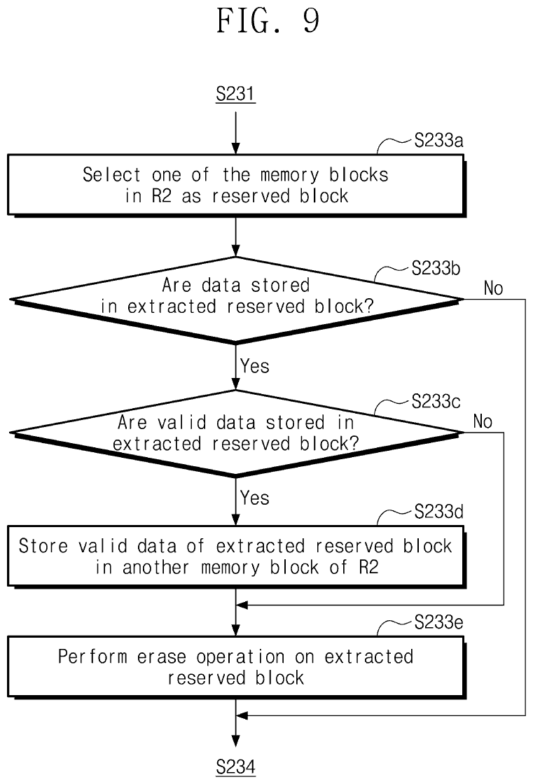

FIG. 8A is a diagram for describing bad block management of a bad block manager of FIG. 1, FIG. 8B is a diagram for describing a bad block mapping table of FIG. 2, and FIG. 8C is a diagram for describing a boundary information table of FIG. 2. FIGS. 8A to 8C will be described with reference to FIGS. 1, 2, and 5A to 7. Referring to FIG. 8A, a first time point t1 may be a time point after the initial allocation for the regions R1 to R4 described with reference to FIG. 5A is completed. At the first time point t1, the bad block manager 111 may check that the fourth memory block BLK4 and the fifth memory block BLK5 among the memory blocks BLK3 to BLK7 of the second region R2 are bad blocks. Also, the bad block manager 111 may check that the eighth memory block BLK8 and the tenth memory block BLK10 among the memory blocks BLK8 to BLK12 of the third region R3 are bad blocks. Each of the memory blocks BLK4, BLK5, BLK8, and BLK10 may be an initial bad block.

Referring to FIG. 8B, the SLC mapping table SMT may include mapping information of a bad block of the second region R2 and a reserved block of the first region R1. The TLC mapping table TMT include mapping information of a bad block of the third region R3 and a reserved block of the fourth region R4. Referring to FIG. 8C, the boundary information table 116 may include the SRB information, the PB information, and the TRB information.

Referring to FIG. 5C, the boundary information table 116 may include the SRB information which indicates a memory block with the highest physical address among the memory blocks of the first region R1. The boundary information table 116 may include the PB information which indicates a memory block with the highest physical address from among the memory blocks of the SLC region. The boundary information table 116 may further include the TRB information which indicates a memory block with the lowest physical address among the memory blocks of the fourth region R4.

At the first time point t1, the bad block manager 111 may check the SRB information in the boundary information table 116. As the SRB information indicates the second memory block BLK2, the bad block manager 111 determines the first and second memory blocks BLK1 and BLK2 as reserved memory blocks of the first region R1 and remaining memory blocks of the SLC region as user memory blocks of the second region R2. The bad block manager 111 may further check the TRB information in the boundary information table 116. As the TRB information indicates the thirteenth memory block BLK13, the bad block manager 111 determines the thirteenth and fourteenth memory blocks BLK13 and BLK14 as reserved memory blocks of the fourth region R4 and remaining memory blocks of the TLC region as user memory blocks of the third region R3. Accordingly, the bad block manager 111 may check that the first memory block BLK1 and the second memory block BLK2 are reserved blocks of the first region R1 and the thirteenth memory block BLK13 and the fourteenth memory block BLK14 are reserved blocks of the fourth region R4.

The bad block manager 111, based on the SLC mapping table SMT, may check whether the first memory block BLK1 and the second memory block BLK2 are available to replace the bad blocks BLK4 and BLK5 of the second region R2 (i.e., that the first memory block BLK1 and the second memory block BLK2 are not used to replace the bad blocks of the second region R2). As the SLC mapping table SMT indicates that the first memory block BLK1 and the second memory block BLK2 are not used for replacing bad blocks, the bad block manager 111 may check that the first memory block BLK1 and the second memory block BLK2 are available reserved blocks.

The bad block manager 111, based on the TLC mapping table TMT, may check whether the thirteenth memory block BLK13 and the fourteenth memory block BLK14 are available to replace the bad blocks BLK8 and BLK10 of the third region R3 (i.e., that the thirteenth memory block BLK13 and the fourteenth memory block BLK14 are not used to replace the bad blocks of the third region R3). As the TLC mapping table TMT indicates that the thirteenth memory block BLK13 and the fourteenth memory block BLK14 are not used for replacing bad blocks, the bad block manager 111 may check that the thirteenth memory block BLK13 and the fourteenth memory block BLK14 are available reserved blocks.

At a second time point t2 of FIG. 8A, the bad block manager 111 may replace the fourth memory block BLK4 with the second memory block BLK2 and may replace the fifth memory block BLK5 with the first memory block BLK1. Likewise, the bad block manager 111 may replace the eighth memory block BLK8 with the fourteenth memory block BLK14 and may replace the tenth memory block BLK10 with the thirteenth memory block BLK13. The bad block manager 111 may move valid data stored in a bad block to the reserved block replacing the bad block before remapping the bad block to the reserved block for replacing the bad block with the reserved block.

Referring to FIG. 8B, at the second time point t2, the bad block manager 111 may update the mapping information of the SLC mapping table SMT and the TLC mapping table TMT. The SLC mapping table SMT may be updated to include mapping information that the bad blocks BLK4 and BLK5 are replaced with the reserved blocks BLK2 and BLK1 respectively. The TLC mapping table TMT may be updated to include mapping information that the bad blocks BLK8 and BLK10 are replaced with the reserved blocks BLK14 and BLK13 respectively. Because the bad block manager 111 may replace the bad blocks BLK4, BLK5, BLK8, and BLK10 with the reserved blocks BLK1, BLK2, BLK13, and BLK14, after the second time point t2, the reserved blocks BLK1, BLK2, BLK13, and BLK14 may become unavailable reserved blocks.

After the second time point t2, the storage controller 110 may receive the program or read request for the fifth memory block BLK5 from the external host device. The program or read request may include logical address to identify each of the program or read request, and the logical address is translated by FTL 117 of FIG. 2 to determine a memory block on which program or read operation is performed in response to the program or read request. The translated physical address indicates the fifth memory block BLK5 in this example embodiment. Because the SLC mapping table SMT indicates that the fifth memory block BLK5 is replaced with the first memory block BLK1, the storage controller 110 may perform the program or read operation on the first memory block BLK1 instead of the fifth memory block BLK5.

At a third time point t3 of FIG. 8A, the bad block manager 111 may check that the sixth memory block BLK6 of the second region R2 and the ninth memory block BLK9 of the third region R3 are bad blocks. Each of the memory blocks BLK6 and BLK9 may be runtime bad block. The runtime bad block may refer to a memory block which becomes a bad block while operating in the storage device 100. The bad block manager 111 may check that the reserved blocks in the first region R1 are not available for replacing the runtime bad block of the second region R2 based on the SLC mapping table SMT and the boundary information table 116. The bad block manager 111 may check that the reserved blocks in the fourth region R4 are not available for replacing the runtime bad block of the third region R3 based on the TLC mapping table TMT and the boundary information table 116.

At a fourth time point t4, the bad block manager 111 may extract the third memory block BLK3 among the memory blocks BLK3 to BLK7 of the second region R2 as a reserved block. The bad block manager 111 may replace the sixth memory block BLK6 with the third memory block BLK3. Likewise, the bad block manager 111 may extract the twelfth memory block BLK12 among the memory blocks BLK8 to BLK12 of the third region R3 as a reserved block. The bad block manager 111 may replace the ninth memory block BLK9 with the twelfth memory block BLK12.

Referring to FIG. 8B, at the fourth time point t4, the bad block manager 111 may update the SLC mapping table SMT to include the mapping information that the bad block BLK6 of the second region R2 is replaced with the extracted memory block BLK3 of the first region R1, and may update the TLC mapping table TMT to include the mapping information that the bad block BLK9 of the third region R3 is replaced with the extracted memory block BLK12 of the fourth region R4.

At a fifth time point t5 of FIG. 8A, the bad block manager 111 may change the SRB information. The SRB information may be changed to indicate the SLC remap boundary SRB is changed to be located between the third memory block BLK3 and the fourth memory block BLK4. The bad block manager 111 may expand the first region R1 by shifting the SLC remap boundary SRB in the direction (e.g., the first direction D1 of FIG. 5B) to increase the number of memory blocks in the first region R1 to decrease the number of memory blocks in the second region R2. As a result of expanding the first region R1, the third memory block BLK3 extracted from the second region R2 may be included in the first region R1 as a reserved block.

The bad block manager 111 may change the TRB information. The TRB information may be changed to indicate that the TLC remap boundary is changed to be located between the eleventh memory block BLK11 and the twelfth memory block BLK12. The bad block manager 111 may expand the fourth region R4 by shifting the TLC remap boundary TRB in the direction (e.g., the second direction D2 of FIG. 5B) to increase the number of memory blocks in the fourth region R4 and to decrease the number of memory blocks in the third region R3. As a result of expanding the fourth region R4, the twelfth memory block BLK12 extracted from the third region R3 may be included in the fourth region R4 as a reserved block.

When a runtime bad block is detected from the second region R2 during the operation of the storage device 100, the bad block manager 111 may expand the first region R1 by changing the SRB information to shift the SLC remap boundary SRB. Likewise, when a runtime bad block is detected from the third region R3 during the operation of the storage device 100, the bad block manager 111 may expand the fourth region R4 by changing the TRB information to shift the TLC remap boundary TRB.

According to an embodiment, the bad block manager 111 may set a limit that the SLC remap boundary SRB can be shifted to increase the number of the memory blocks in the first region R1. The limit may be set based on the capacity of the first region R1 and the second region R2. For example, the bad block manager 111 may change the SRB information to shift the SLC remap boundary SRB within the limit in which the number of memory blocks of the first region R1 is not more than the number of memory blocks of the second region R2.

In addition, the bad block manager 111 may set a limit that the TLC remap boundary TRB can be shifted to increase the number of the memory blocks in the fourth region R4. The limit may be set based on the capacity of the third region R3 and the fourth region R4. For example, the bad block manager 111 may shift the TLC remap boundary TRB within the limit in which the number of memory blocks of the fourth region R4 is not more than the number of memory blocks of the third region R3.

Referring to FIG. 8C, at a fifth time point t5, the bad block manager 111 may update the SRB information and the TRB information in the boundary information table 116.

According to an embodiment of the present disclosure, the storage controller 110 may replace initial bad blocks with reserved blocks of a reserved region. After the initial bad blocks are replaced, and while the non-volatile memory device 120 is operating in the storage device 100, a runtime bad block may be detected as program and erase cycles are repeated on the memory blocks of the non-volatile memory device 120. As the runtime bad blocks are replaced with reserved blocks of the reserved region, reserved blocks of the reserved region may be exhausted within a certain operation period. More particularly, either the reserved blocks for the SLC region in the first region R1 or the reserved blocks for the TLC region in the fourth region R4 may be exhausted. According to an embodiment of the present disclosure, the storage controller 110 may change either the SRB information or the TRB information to secure further reserved blocks depending on whether the reserved blocks for the SLC region in the first region R1 are exhausted or the reserved blocks for the TLC region in the fourth region R4 are exhausted. Accordingly, the storage controller 110 may manage bad blocks of the user region without using a reserved block of the SLC region for replacing a bad block of the TLC region and without using a reserved block of the TLC region for replacing a bad block of the SLC region.

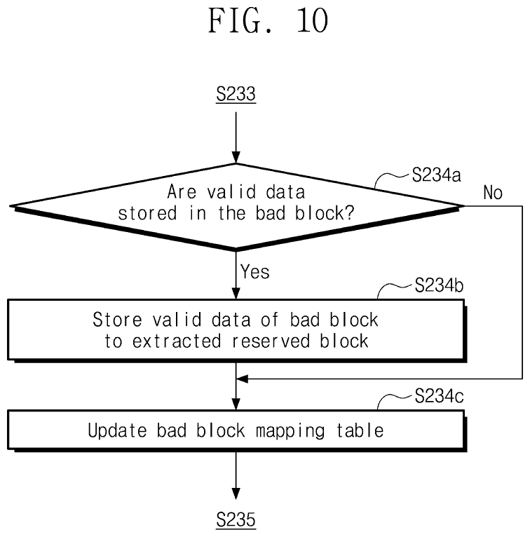

FIG. 9 is a flowchart for describing a reserved block extracting operation of FIG. 7. Referring to FIG. 9, in operation S233a, the storage controller 110 may select one of the memory blocks of the second region R2 as a reserved block. For example, the bad block manager 111 may select a memory block (e.g., BLK3), which is not a bad block among the memory blocks (e.g., BLK3 to BLK7 of FIG. 8A) of the second region R2, as a reserved block. The storage controller 110 may select a free block first among the memory blocks of the second region R2 as a reserved block. The free block refers to a memory block in which data are not stored. However, when free blocks are exhausted in the second region, the storage controller 110 may select a memory block which is not a free block as a reserved block.

In operation S233b, the storage controller 110 may determine whether the extracted reserved block is a free block or not. When it is determined that the extracted reserved block is not a free block and the data are stored in the extracted reserved block, the storage controller 110 may perform operation S233c. When it is determined that the extracted reserved block is a free block and the data are not stored, the storage controller 110 may perform operation S234.

In operation S233c, the storage controller 110 may determine whether the data stored in the extracted reserved block are valid. When it is determined that the stored data are valid, the storage controller 110 may perform operation S233d. When it is determined that the stored data are not valid, the storage controller 110 may perform operation S233e.

In operation S233d, the storage controller 110 may move the valid data stored in the extracted reserved block to another memory block of the second region R2.

In operation S233e, the storage controller 110 may perform the erase operation on the extracted reserved block for turning the extracted reserved block into a free block in which data are not stored.

By moving valid data in the extracted reserved block to another memory block of the second region R2, the non-volatile memory device 120 may retain the valid data continuously in another memory block. Accordingly, the storage controller 110 may prevent the loss of valid data due to the extraction of the reserved block.

The reserved block extracting operation of FIG. 9 performed by the storage controller 110 may be performed in particular by the bad block manager 111.

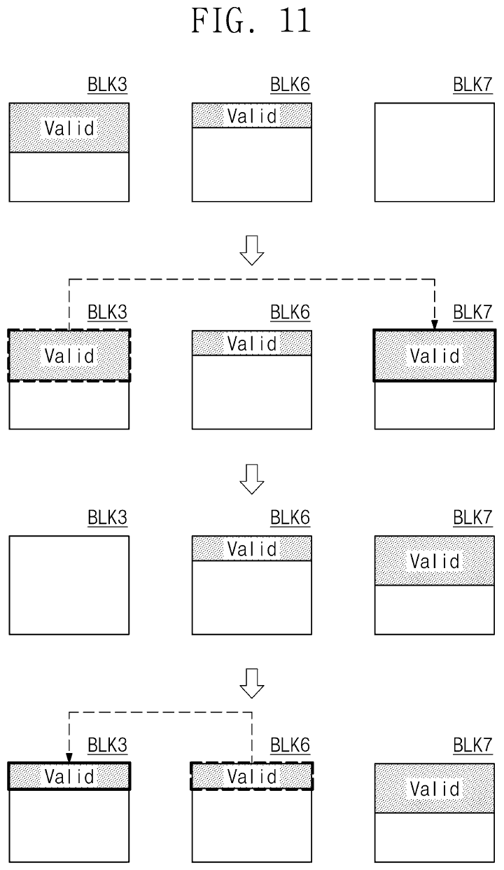

FIG. 10 is a flowchart for describing an operation of performing a remap operation on an extracted reserved block and a bad block, which is described with reference to FIG. 7. Referring to FIG. 10, in operation S234a, the storage controller 110 may determine whether valid data are stored in the bad block. When it is determined that the valid data are stored in the bad block, the storage controller 110 may perform operation S234b. When it is determined that the valid data are not stored in the bad block, the storage controller 110 may perform operation S234c.

In operation S234b, the storage controller 110 may move the valid data stored in the bad block to the extracted reserved block.

In operation S234c, the storage controller 110 may update the bad block mapping table 115. The storage controller 110 may update mapping information of the bad block and the extracted reserved block in the bad block mapping table 115.

Updating the mapping information of the bad block and the extracted reserved block described with reference to FIG. 10 may be performed in the same manner as described in operation S234 of FIG. 7. Likewise, Updating mapping information of the bad block and the available reserved block described with reference to FIG. 10 may be performed in the same manner as described in operation S232 of FIG. 7 which is similar to operation S234 of FIG. 7. For example, when the stored data in the bad block are valid, the storage controller 110 may move the valid data in an available reserved block of the first region R1 and may then update the bad block mapping table 115 to perform the remap operation on the available reserved block and the bad block.

The remap operation of FIG. 10 described to be performed by the storage controller 110, may be performed in particular by the bad block manager 111.

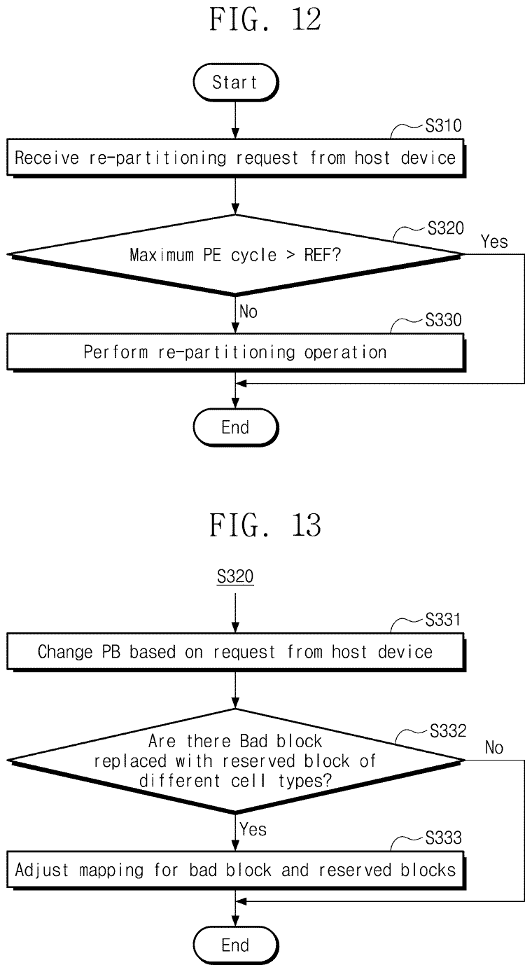

FIG. 11 is a diagram for describing operations of FIGS. 9 and 10. FIG. 11 will be described with reference to FIGS. 1, 2, and 5 to 10. Referring to FIG. 11, the third memory block BLK3 may be a reserved block extracted from the second region R2, the sixth memory block BLK6 may be a bad block of the second region R2, and the seventh memory block BLK7 may be a memory block of the second region R2. The third memory block BLK3 and the sixth memory block BLK6 may be memory blocks in which valid data are stored.

The bad block manager 111 may move the valid data stored in the third memory block BLK3 to the seventh memory block BLK7 and may then perform the erase operation on the third memory block BLK3. Thereafter, the bad block manager 111 may move the valid data stored in the sixth memory block BLK6 to the third memory block BLK3 and may update mapping information of the sixth memory block BLK6 and the third memory block BLK3 in the bad block mapping table 115. Accordingly, the bad block manager 111 may replace the bad block (i.e., the sixth memory block BLK6) with the extracted reserved block (i.e., the third memory block BLK3) without the loss of valid data.

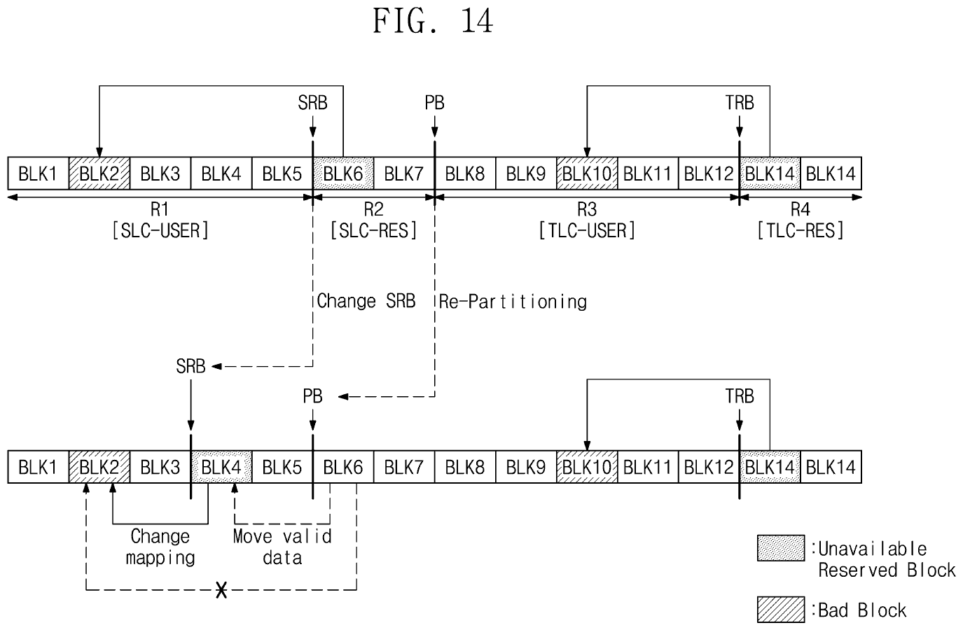

FIG. 12 is a flowchart for describing a re-partitioning operation of a storage controller of FIG. 1. The re-partitioning operation described with reference to FIG. 12 may be performed after the initial allocation operation on the regions R1 to R4 of FIG. 5A is performed. In operation S310, the storage controller 110 may receive the re-partitioning request for changing the partition boundary PB from the external host device.

In operation S320, the storage controller 110 may count program/erase cycles for each of the memory blocks of the non-volatile memory device 120 and determine whether a maximum program/erase cycle among the counted program/erase cycles is greater in value than a reference cycle REF. The maximum program/erase cycle may correspond to highest value among the program/erase cycles counted for each of the memory blocks (e.g., BLK1 to BLK14) in the non-volatile memory device 120. For example, the partition manager 112 may check the maximum program/erase cycle among the program/erase cycles counted for each of the memory blocks and determine whether the maximum program/erase cycle is greater in value than the reference cycle REF. The reference cycle REF may be predetermined depending on an application of the non-volatile memory device 120. For example, the reference cycle REF may be ten. The program/erase cycles counted for each of memory blocks and the reference cycle REF may be stored in the buffer memory 114. When the maximum program/erase cycle is greater in value than the reference cycle REF, the storage controller 110 may not perform the re-partitioning operation in response to the re-partitioning request. When the maximum program/erase cycle is equal to or smaller in value than the reference cycle REF, the storage controller 110 may perform operation S230 in response to the re-partitioning request.

In operation S330, the storage controller 110 may perform the re-partitioning operation. For example, the partition manager 112 may change the PB information to shift the partition boundary PB during the re-partitioning operation.

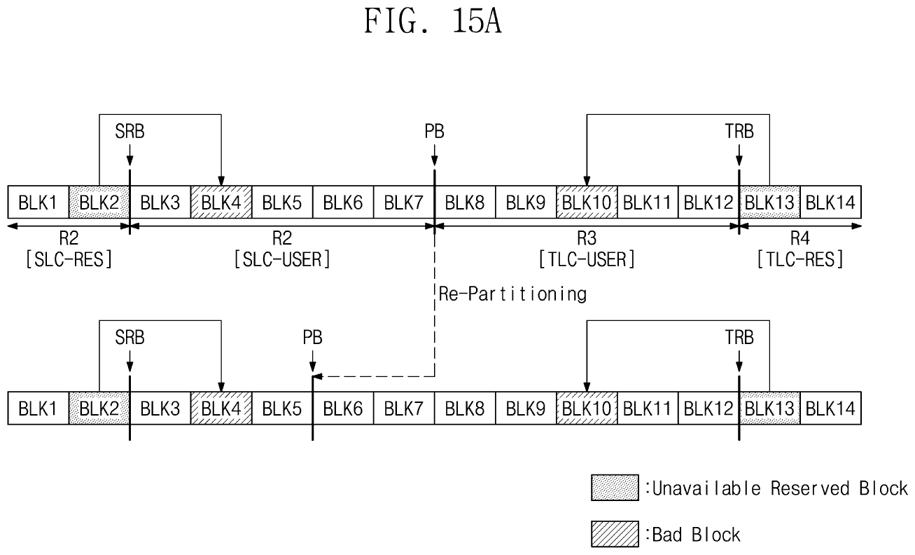

FIG. 13 is a flowchart for describing a re-partitioning operation of FIG. 12. Referring to FIG. 13, in operation S331, the storage controller 110 may change the PB information to shift the partition boundary PB based on a request from the host device. The partition manager 112 may change the PB information to shift the partition boundary PB to a changed location based on the re-partitioning request from the host device and may update the PB information in the boundary information table 116.

As a result of the re-partitioning operation of FIG. 12, a bad block may be re-partitioned to a different cell type region. Therefore, the cell type of the re-partitioned bad block may become different from the cell type of the reserved block which replaced the re-partitioned bad block before the re-partitioning operation. In operation S332, the storage controller 110 may detect whether a bad block is replaced with a reserved block with a different cell type. When a bad block replaced with a reserved block with a different cell type is detected, the storage controller 110 may perform operation S333.

For example, when a bad block of the SLC region replaced with a reserved block of the SLC region is re-partitioned into the TLC region due to the re-partitioning operation or when a bad block of the TLC region replaced with a reserved block of the TLC region is re-partitioned into the SLC region due to the re-partitioning operation, the bad block manager 111 may determine that a bad block replaced with a reserved block with a different cell type exists.

In operation S333, the storage controller 110 may adjust mapping between a bad block and reserved blocks. For example, the bad block manager 111 may remove mapping between the reserved block of the SLC region and the bad block of the TLC region which is established before the re-partitioning operation, and may remap the bad block of the TLC region to a reserved block of the TLC region.

The bad block manager 111 may remove mapping between a reserved block of the TLC region and a bad block of the SLC region which is established before the re-partitioning operation, and may remap the bad block of the SLC region to a reserved block of the SLC region. Accordingly, even after the re-partitioning operation is performed, the storage controller 110 may not use reserved blocks of the SLC region to replace bad blocks of the TLC region and may not use reserved blocks of the TLC region to replace bad blocks of the SLC region.

According an embodiment, unlike the example illustrated in FIG. 13, the storage controller 110 may not perform operation S332 and operation S333 of FIG. 13, and may change only the location of the partition boundary PB and may not adjust mapping between reserved blocks and a bad block while performing the re-partitioning operation.

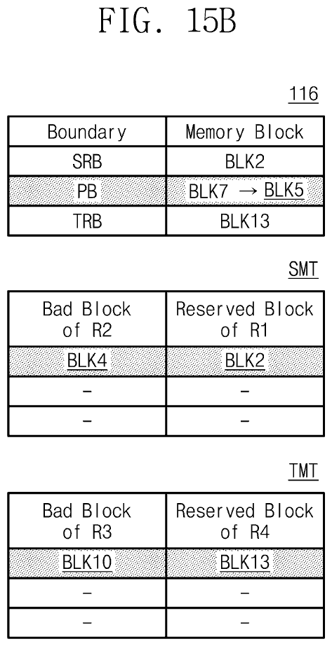

FIG. 14 is a diagram for describing an example of a re-partitioning operation. Referring to FIG. 14, the first region R1 may include the first memory block BLK1 to the fifth memory block BLK5 and may be the SLC user region SLC-USER in which user data are stored. The second region R2 may include the sixth memory block BLK6 and the seventh memory block BLK7, and the second region R2 may be the SLC reserved region SLC-RES for replacing a bad block of the first region R1. The third region R3 may include the eighth memory block BLK8 to the twelfth memory block BLK12 and may be the TLC user region TLC-USER in which user data are stored. The fourth region R4 may include the thirteenth memory block BLK13 and the fourteenth memory block BLK14, and the fourth region R4 may be the TLC reserved region TLC-RES for replacing a bad block of the third region R3.

According to an example embodiment of FIG. 14, the SLC reserved region SLC-RES may be disposed adjacent to the TLC user region TLC-USER.

For example, the second memory block BLK2 may be a bad block and may be replaced with the sixth memory block BLK6, and the tenth memory block BLK10 may a bad block and may be replaced with the fourteenth memory block BLK14. The partition boundary PB may be located between the seventh memory block BLK7 and the eighth memory block BLK8.

The partition manager 112 may change the PB information to shift the partition boundary PB through the re-partitioning operation. The partition boundary PB may be located between the fifth memory block BLK5 and the sixth memory block BLK6 as shown in FIG. 14. As a result of the re-partitioning operation, the sixth memory block BLK6 and the seventh memory block BLK7 may be included in the third region R3 of the TLC region. Accordingly, the sixth memory block BLK6 and the seventh memory block BLK7 may not be used to replace a bad block (e.g., the second memory block BLK2) of the first region R1.

For securing a reserved block for replacing the bad block of the first region R1, the bad block manager 111 may change the SRB information to shift the SLC remap boundary SRB to be located between the third memory block BLK3 and the fourth memory block BLK4. Accordingly, the fourth memory block BLK4 and the fifth memory block BLK5 may be included in the second region R2 and may be used as a reserved block for replacing a bad block of the first region R1.

The bad block manager 111 may change a mapping relationship to indicate that the second memory block BLK2, which is a bad block of the first region R1, is replaced with the fourth memory block BLK4 of the second region R2. More specifically, as the bad block manager 111 replaces the second memory block BLK2 before the execution of the re-partitioning operation, valid data stored in the sixth memory block BLK6 may be moved to the fourth memory block BLK4. Additionally, the bad block manager 111 may remove mapping between the second memory block BLK2 and the sixth memory block BLK6 and may remap the second memory block BLK2 to the fourth memory block BLK4. The bad block manager 111 may update the bad block mapping table 115 to adjust the mapping relationship between the second memory block BLK2 and the fourth memory block BLK4.

When the SLC reserved region SLC-RES, the SLC user region SLC-USER, the TLC user region TLC-USER, and the TLC reserved region TLC-RES are not sequentially disposed, the mapping relationship between reserved blocks and bad blocks should be adjusted whenever the re-partitioning operation is performed, thereby reducing the performance of the storage device 100.

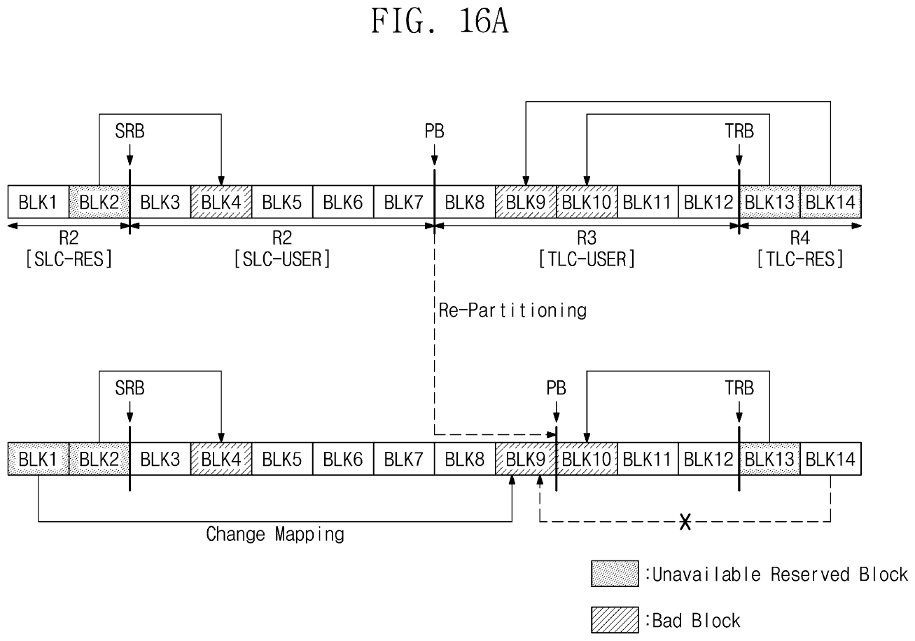

FIGS. 15A and 15B are diagrams for describing an example of a re-partitioning operation according to an embodiment of the present disclosure. FIGS. 15A and 15B will be described with reference to FIGS. 1, 2, and 5A to 13. Referring to FIG. 15A, the fourth memory block BLK4 of the second region R2 may be replaced with the second memory block BLK2 of the first region R1, and the tenth memory block BLK10 of the third region R3 may be replaced with the thirteenth memory block BLK13 of the fourth region R4. The partition boundary PB may be located between the seventh memory block BLK7 and the eighth memory block BLK8.

The partition manager 112 may perform the re-partitioning operation in response to a re-partitioning request from the external host device. The partition manager 112 may change a location of the partition boundary PB through the re-partitioning operation in response to the re-partitioning request. As a result of the re-partitioning operation, the partition boundary PB may be located between the fifth memory block BLK5 and the sixth memory block BLK6. Referring to FIG. 15B, the partition manager 112 may shift the partition boundary PB by changing the PB information in the boundary information table 116.

As illustrated in FIG. 15A, according to an embodiment of the present disclosure, the SLC reserved region SLC-RES may be adjacent to the SLC user region SLC-USER, the SLC user region SLC-USER may be adjacent to the TLC user region TLC-USER, the TLC user region TLC-USER may be adjacent to the TLC reserved region TLC-RES, and the TLC reserved region TLC-RES may not be adjacent to the SLC reserved region SLC-RES. Accordingly, even after the re-partitioning operation, the SLC remap boundary SRB and the TLC remap boundary TRB may not be changed.

Accordingly, after the re-partitioning operation is performed, the bad block manager 111 may not change mapping relationships between the bad blocks BLK4 and BLK10 and the reserved blocks BLK2 and BLK13. Referring to FIG. 15B, the bad block manager 111 may not update the SLC mapping table SMT and the TLC mapping table TMT. Accordingly, the performance of the storage device 100 may be improved compared with the performance of the example described with reference to FIG. 14.

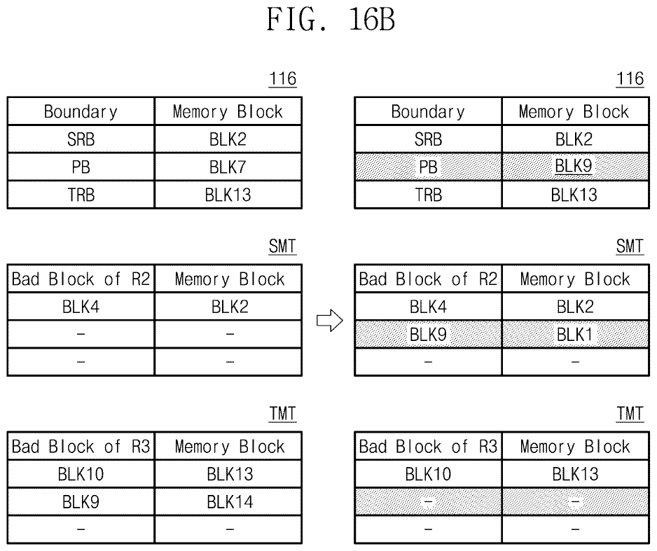

FIGS. 16A and 16B are diagrams for describing another example of a re-partitioning operation according to an embodiment of the present disclosure. FIGS. 16A and 16B will be described with reference to FIGS. 1, 2, and 5A to 13. Referring to FIG. 16A, the fourth memory block BLK4 of the second region R2 may be replaced with the second memory block BLK2 of the first region R1, the tenth memory block BLK10 of the third region R3 may be replaced with the thirteenth memory block BLK13 of the fourth region R4, and the ninth memory block BLK9 of the third region R3 may be replaced with the fourteenth memory block BLK14 of the fourth region R4. The partition boundary PB may be located between the seventh memory block BLK7 and the eighth memory block BLK8.

The partition manager 112 may perform the re-partitioning operation in response to the re-partitioning request from the external host device. The partition manager 112 may change the PB information for the partition boundary PB to be located between the ninth memory block BLK9 and the tenth memory block BLK10 through the re-partitioning operation. Referring to FIG. 16B, the partition manager 112 may change the partition boundary PB by changing the PB information in the boundary information table 116.

As a result of the re-partitioning operation described with reference to FIG. 16A, the ninth memory block BLK9 replaced with the fourteenth memory block BLK14 of the fourth region R4 of the TLC region may be included in the second region R2 of the SLC region. When the mapping relationship associated with the ninth memory block BLK9 is not changed, the ninth memory block BLK9 may be replaced with the fourteenth memory block BLK14 of the TLC region.

Therefore, after the re-partitioning operation, the bad block manager 111 may remove mapping between the ninth memory block BLK9 and the fourteenth memory block BLK14 and may remap the ninth memory block BLK9 to the first memory block BLK1. More particularly, the bad block manager 111 may move valid data of the fourteenth memory block BLK14 to the first memory block BLK1 and may remap the ninth memory block BLK9 to the first memory block BLK1 by changing the mapping relationship associated with the ninth memory block BLK9.

Referring to FIG. 16B, the bad block manager 111 may change the mapping relationship between the first memory block BLK1 and the ninth memory block BLK9 by deleting the mapping information of the ninth memory block BLK9 and the fourteenth memory block BLK14 in the TLC mapping table TMT and updating the mapping information of the first memory block BLK1 and the ninth memory block BLK9 in the SLC mapping table SMT. Accordingly, after the re-partitioning operation, the bad block manager 111 may not use a reserved block of the TLC region (i.e., the fourth region R4) for replacing a bad block of the SLC region (i.e., the second region R2).

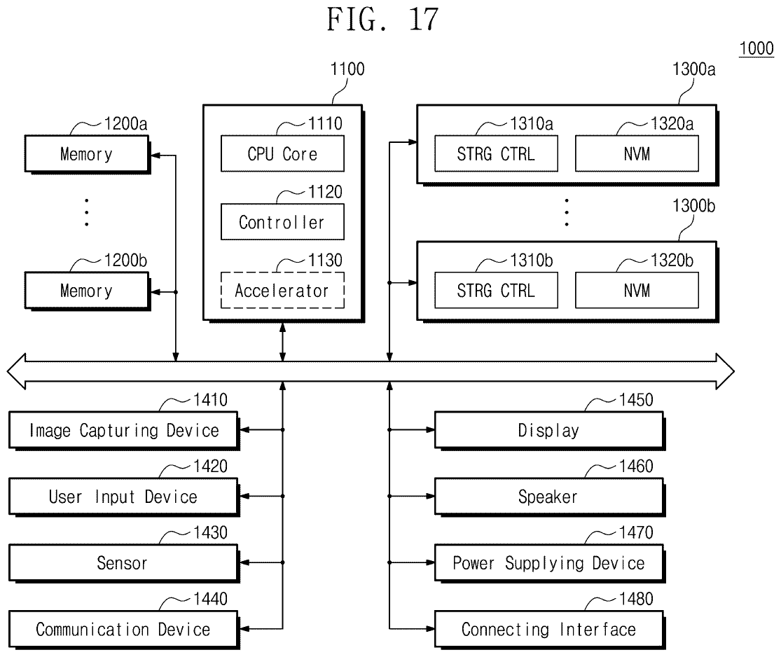

FIG. 17 is a diagram of a system 1000 to which a storage device is applied, according to an embodiment. The system 1000 of FIG. 17 may basically be a mobile system, such as a portable communication terminal (e.g., a mobile phone), a smartphone, a tablet personal computer (PC), a wearable device, a healthcare device, or an Internet of Things (IoT) device. However, the system 1000 of FIG. 17 is not necessarily limited to the mobile system and may be a PC, a laptop computer, a server, a media player, or an automotive device (e.g., a navigation device).

Referring to FIG. 17, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and non-volatile memories (NVMs) 1320a and 1320b configured to store data via the control of the storage controllers 1310a and 1310b. Although the NVMs 1320a and 1320b may include flash memories having a two-dimensional (2D) structure or a three-dimensional (3D) vertical-NAND (V-NAND) structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards which may be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery (not shown) embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

The storage device 100 described with reference to FIGS. 1 to 13 and 15A to 16B may be applied to the storage devices 1300a and 1300b. The storage devices 1300a and 1300b may replace a bad block of the user region with a reserved block with the same cell type. By applying the storage device 100, described with reference to FIGS. 1 to 13 and 15A to 16B, to the storage devices 1300a and 1300b of FIG. 17, the storage devices 1300a and 1300b may take advantage of the present inventive concept.

According to the present disclosure, a component may be indicated by the term “first”, “second”, or “third”,. However, the terms “first”, “second”, “third”, etc. may be used to distinguish components from each other and do not limit the present disclosure. For example, the terms “first”, “second”, or “third” are not related with an order or a numerical meaning in any form.

According to embodiments of the present disclosure, components are referenced through blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. Additionally, the blocks may include circuits implemented with semiconductor elements in an integrated circuit, or circuits enrolled as an intellectual property (IP).

According to the present disclosure, a storage device may include a non-volatile memory device including a first region to a fourth region. The storage device may replace a bad block of the second region with a memory block of the first region and may replace a bad block of the third region with a memory block of the fourth region. A first boundary between the first region and the second region and a second boundary between the third region and the fourth region may not be changed, even when a third boundary between the second region and the third region is changed. Therefore, the storage device may efficiently manage the first region to the fourth region. Accordingly, a storage device with an improved performance storage controller, along with an operation method of the storage controller, is provided.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A storage device comprising:
a non-volatile memory device; and
a storage controller, the storage controller being configured to store first boundary information, second boundary information and third boundary information,
wherein the non-volatile memory device includes a first memory region and a second memory region distinguished through a first boundary identified by the first boundary information of the storage controller, each of the first memory region and the second memory region including a plurality of memory blocks,
wherein the first memory region is divided into a first region and a second region, the first region includes a plurality of first reserved blocks, the second region includes a plurality of first user memory blocks, a second boundary between the first region and the second region is identified by the second boundary information of the storage controller,
wherein the second memory region is divided into a third region and a fourth region, the third region includes a plurality of second user memory blocks, the fourth region includes a plurality of second reserved blocks, and a third boundary between the third region and the fourth region is identified by the third boundary information of the storage controller,
wherein the storage controller is configured to replace a bad block of the second region with a corresponding first reserved block and cause the first reserved block to be identified as a first user memory block,
wherein the storage controller is configured to replace a bad block of the third region with a corresponding second reserved block and cause the second reserved block to be identified as a second user memory block, and
wherein each memory cell in the first memory region is configured to store m-bit data, and each memory cell in the second memory region is configured to store n-bit data, and m and n are natural numbers and are different from each other.

2. The storage device of claim 1, wherein, when a first reserved block for replacing the bad block of the second region is unavailable among the plurality of first reserved blocks in the first region, the storage controller is configured to expand the first region by changing the second boundary information to increase the number of first reserved blocks in the first region and to decrease the number of first user memory blocks in the second region.

3. The storage device of claim 2, wherein the storage controller is further configured to change the second boundary information, through which at least one user memory block of the second region is included in the first region.

4. The storage device of claim 2, wherein, when a second reserved block for replacing the bad block of the third region is unavailable among the plurality of second reserved blocks in the fourth region, the storage controller is further configured to expand the fourth region by changing the third boundary information to increase the number of the second reserved blocks in the fourth region and to decrease the number of the second user memory blocks in the third region.

5. The storage device of claim 1, wherein the storage controller is configured to change the first boundary information in response to a re-partitioning request from an external host device.

6. The storage device of claim 5, wherein, in response to the re-partitioning request, the storage controller is further configured to analyze program/erase cycles counts for each of memory blocks of the non-volatile memory device, and in response to the maximum program/erase cycle count of the memory blocks being smaller than or equal to a reference cycle value, the storage controller is further configured to change the first boundary information.

7. The storage device of claim 5, wherein, when the first boundary information is changed and the second boundary information and the third boundary information are not changed, the number of the first user memory blocks and the number of the second user memory block are changed by the change of the first boundary information.

8. The storage device of claim 1, wherein the storage controller includes:
a first mapping table configured to include mapping information the bad block of the second region and a corresponding first reserved block of the first region to replace the bad block of the second region; and
a second mapping table configured to include mapping information the bad block of the third region and a corresponding second reserved block of the fourth region to replace the bad block of the third region.

9. The storage device of claim 8, wherein the storage controller further includes a boundary information table configured to include the first boundary information, the second boundary information, and the third boundary information.

10. The storage device of claim 8, wherein the storage controller is further configured to:
move first valid data stored in the bad block of the second region to the first reserved block of the first region;
move second valid data stored in the bad block of the third region to the second reserved block of the fourth region; and
update mapping information with respect to the bad block of the second region and the corresponding first reserved block in the first mapping table for storing information that the bad block of the second region is replaced with the corresponding first reserved block of the first region, and update mapping information with respect to the bad block of the third region and the corresponding second reserved block in the second mapping table for storing information that the bad block of the third region is replaced with the corresponding second reserved block of the fourth region.

11. The storage device of claim 1, wherein the second region is adjacent to the third region, the first memory region is a single level cell (SLC) region, and the second memory region is a triple level cell (TLC) region.

12. An operation method of a storage controller for controlling a non-volatile memory device which includes a first memory region and a second memory region distinguished by first boundary information, and each of the first and second memory regions including a plurality of memory blocks, the method comprising:
dividing the first memory region into a first region and a second region through second boundary information;
dividing the second memory region into a third region and a fourth region through third boundary information;
replacing a first bad block of the second region with a first memory block among the plurality of memory blocks of the first region;
replacing a second bad block of the third region with a second memory block among the plurality of memory blocks of the fourth region;
extracting a third memory block among the plurality of memory blocks of the second region as a reserved block;
replacing a second bad block of the second region with the third memory block; and
expanding the first region to include the third memory block, by changing the second boundary between the first region and the second region,
wherein each memory cell of the first memory region is configured to store m-bit data, and each memory cell of the second memory region is configured to store n-bit data, and m and n are natural numbers and different from each other.

13. The method of claim 12, further comprising:
receiving a re-partitioning request from an external host device; and
changing first boundary information in response to the re-partitioning request,
wherein, when the first boundary information is changed and the second boundary and the third boundary are not changed, the number of memory blocks of the second region and the number of the memory blocks of the third region are changed by the first boundary information.

14. The method of claim 13, further comprising:
counting program/erase cycles for each of the plurality of memory blocks;
determining, in response to the re-partitioning request, whether a maximum program/erase cycle of a memory block among the program/erase cycles counted for each of the plurality of memory blocks is smaller than or equal to a reference cycle in value, in which the maximum program/erase cycle corresponds to highest value among the program/erase cycles counted for each of memory blocks in the non-volatile memory device; and
upon determining that the maximum program/erase cycle of the memory block is smaller than or equal to the reference cycle in value, changing the first boundary information.

15. The method of claim 12, wherein, replacing of the second bad block with the third memory block includes:
moving valid data of the third memory block to a fourth memory block among the plurality of memory blocks of the second region;
performing an erase operation on the third memory block; and
moving valid data of the second bad block to the third memory block.

16. The method of claim 12, wherein the first memory region is a single level cell (SLC) region, and the second memory region is a triple level cell (TLC) region.

17. The method of claim 12, further comprising:
replacing a third bad block of the third region with a fifth memory block among the plurality of memory blocks of the fourth region.

18. The method of claim 17, wherein, expanding of the first region includes changing the second boundary information to increase a number of memory blocks in the first region and to decrease a number of memory blocks in the second region, and the method further comprises, when a memory block for replacing a fourth bad block of the third region is unavailable in the fourth region, expanding the fourth region by changing the third boundary information to increase a number of memory blocks in the fourth region and to decrease a number of memory blocks in the third region.

19. The method of claim 12, wherein the first region is adjacent to the second region, the third region is adjacent to the second region, and the fourth region is adjacent to the third region.

20. A storage device comprising:
a non-volatile memory device including a plurality of memory blocks; and
a storage controller,
wherein the storage controller is configured to:
allocate the plurality of memory blocks to a first memory region and a second memory region through a first boundary information in response to a first request from an external host device;
divide the first memory region into a first region and a second region through a second boundary information based on a number of initial bad blocks of the first memory region;
replace a bad block of the second region with a first memory block among the plurality of memory blocks of the first region;
divide the second memory region into a third region and a fourth region through a third boundary information based on the number of initial bad blocks of the second memory region, in which the third region is adjacent to the second region and the fourth region adjacent to the third region;
replace a bad block of the third region with a second memory block among the plurality of memory blocks of the fourth region;
change the second boundary information based on a number of runtime bad blocks of the second region; and
change the third boundary information based on a number of runtime bad blocks of the third region,
wherein each memory cell of the first memory region stores m-bit data, each memory cell of the second memory region stores n-bit data, and m and n are natural numbers and different from each other.
